(19) United States
(12) Patent Application Publication
(10) Pub. No.: US 2017/0203201 A1
(43) Pub. Date: Jul. 20, 2017

(54) Word games anyone can win & more better bananagrams, boggle, and scrabble games

(71) Applicant: GUY L. MCCLUNG, III, SAN ANTONIO, TX (US)

(72) Inventor: GUY L. MCCLUNG, III, SAN ANTONIO, TX (US)

(21) Appl. No.: 15/330,545

(22) Filed: Oct. 6, 2016

Related U.S. Application Data
(62) Division of application No. 13/694,275, filed on Nov. 14, 2012, now abandoned.

(51) Int. Cl. A63F 3/04; A63F 13/335; A63F 13/80; A63F 3/00; A63F 1/04

(52) U.S. Cl. CPC A63F 3/0423; A63F 3/00643; A63F 1/04; A63F 13/80; A63F 13/335; A63F 2003/00813; A63F 2003/00996; A63F 2003/0428

(57) ABSTRACT

Methods and apparatuses for word games in which a non-acting player may score points based on a score awarded to an acting player.

### RELATED APPLICATIONS

This is a division of U.S. application Ser. No. 13/694,275, filed Nov. 14, 2012. The present invention and application, under the U.S. Patent Laws, claim priority from the following U.S. patent applications: U.S. Ser. No. 13/694,275 filed Nov. 14, 2012; U.S. Ser. No. 61/688,526 filed May 16, 2012; and U.S. Ser. No. 61/629,232 filed Nov. 15, 2011, all said applications incorporated fully herein for all purposes.

### BACKGROUND OF THE INVENTION

1. Field of the Invention

The present invention discloses, inter alia, word games in which an acting player achieves a word score and then one (or more than one) non-acting player(s) can achieve a score based on the acting player's action and/or score. In one particular aspect, the acting player also has the chance to an additional score after receiving the word score or has the chance to receive an additional score.

2. Description of Related Art

There are a wide variety of well-known word games, including, but not limited to, SCRABBLE (trademark) game, BOGGLE (trademark) game, and BANANAGRAMS (trademark) game. No word game known to the present inventor makes provision for the new and nonobvious possibility of a non-acting player receiving a score based on the action of an acting player. No word game known to the present inventor provides the new and nonobvious possibility for a non-acting player to receive a score based, in whole or in part, on chance.

### BRIEF SUMMARY OF THE INVENTION

The present invention discloses, in certain aspects, games in which before an acting player receives a word score (e.g., for producing a word, making a word, finding a word), a determination is made regarding who, if any, of the other player(s) (and, in one aspect, the acting player himself or herself) will either receive an additional score or have the chance to receive an additional score. Such a determination may be made by chance or according to pre-set rules or agreement, a specific player is designated; e.g., if there are only two players, then it is the other player or, e.g., it is always a player to the right or to the left of an acting player, or it is all non-acting players; also e.g., if there are two players, tokens or game pieces (e.g., cards) are dealt or chosen or distributed, and some indicator indicates which player will be able to receive an additional score or have the chance to receive an additional score.

Alternatively, before an acting player takes a turn, by chance a determination is made regarding which player will receive an additional score based on the acting player's score or receive a chance to receive an additional score.

In certain aspects of games according to the present invention, after an acting player receives a word score (e.g., for producing a word, making a word, finding a word), a determination is made regarding who, if any, of the other player(s) (and, in one aspect, the acting player himself or herself) will either receive an additional score or have the chance to receive an additional score. Such a determination may be made by chance or according to pre-set rules or agreement, a specific player is designated; e.g., if there are only two players, then it is the other player or, e.g., it is always a player to the right or to the left of an acting player, or it is all non-acting players; also e.g., if there are two players, tokens or game pieces (e.g., cards) are dealt or chosen or distributed, and some indicator indicates which player will receive an additional score or have the chance to receive an additional score. Alternatively, after an acting player takes a turn, by chance a determination is made regarding which player will receive an additional score based on the acting player's score or receive a chance to receive an additional score.

Any “additional score” herein may be less than, equal to, or greater than a score achieved by an acting player. Rules or pre-game agreement may establish who may be entitled to an additional score or chance to receive it, the value of an additional score, and/or the method of determining the value of an additional score. Who is entitled to an additional score or chance thereof may itself be determined by chance, before or after an acting player is awarded a word score (and this can be limited to only non-acting players or may include the acting player also). Rules or pre-game agreement may establish when any “chance” is possible, what type of chance determinator is used, e.g., but not limited to, a roll of a die, a roll of dice, a spin of a wheel with an indicator that stops at a symbol or a number, a roulette-type rotating wheel and ball with numbers and/or symbols on the wheel, drawing a card or cards, dealing a card or cards, and/or an electronic or mechanical random generator that randomly generates a number or a symbol.

In one aspect, for any game herein, an additional score is determined by taking a percentage of a word score awarded to an acting player. The percentage may be based on rules, a pre-game agreement, or by chance. The percentage may be any chosen percent, e.g., but not limited to 50% or 100% of an acting player's word score, and it may be more than 100%, e.g., but not limited to 200%. In one particular example, a percent is determined by the roll of dice and the percentage is 1/10th of the total sum of the dice; for example, if the dice total 7, then the percentage is 70% or if the dice total 10, the percentage is 100% (and if the dice total 12, the percentage is 120%).

In one particular aspect, the sum of the numerals on the upturned faces of the dice determines whether the percentage is one pre-set percentage or another; e.g., it is agreed or set by the rules that if the total is 1-7, then the percentage is 50% and if the total is more than 7, then the percentage is 100%. In another aspect, the percentage is 50%, unless the total is 7 (or 7 or 11), in which case the percentage is 100%.

In any game herein in which a non-acting player can receive an additional score, by rules or by pre-game agreement the possibility of receiving an additional score can go into effect only upon the occurrence of a pre-determined event or pre-determined score level. In one aspect, no additional score or chance thereof is possible for any player until at least one player (or two, or more) achieves a pre-determined score level. In another aspect, no additional score or chance thereof is possible until all players have taken a pre-set number of turns.

In certain aspects, an award of additional score or the chance to receive an additional score does not come into effect during a game (any herein with designators), until a pre-set or pre-agreed upon number of designators have been used.

In certain aspects, the present invention provides improvements to the SCRABBLE (trademark) game including: any of the features or aspects of any game according to the present invention described herein which can be used in or applied to such a game. In one particular aspect, in an improved SCRABBLE (trademark) game, upon an acting player completing a turn an receiving a score for making a word, a non-acting player (chosen or designated; e.g., in any way described above) rolls two dice and, if the sum of the numerals on the up faces is not 7, the non-acting player received half the word score previously achieved by the acting player, and, if the sum is 7 (or 7 or 11), the non-acting player receives the same score, the word score, which the acting player received. In another aspect, the chosen or designated non-acting player receives a percentage of the acting player's word score, determined in any chosen way, e.g., as described above.

In certain aspects, the present invention provides improvements to the BOGGLE (trademark) game including: any of the features or aspects according to the present invention described here which can be applied to or used in such a game. In one particular aspect, in an improved BOGGLE (trademark) game, upon an acting player completing adding up a total score for that turn of the game, and receiving the totaled score for finding words, a non-acting player (chosen or designated; e.g., in any way described above) rolls two dice and, if the sum of the numerals on the up faces is not 7, the non-acting player received half the totaled score previously achieved by the acting player, and, if the sum is 7 (or 7 or 11), the non-acting player receives the same totaled score which the acting player received. In another aspect, the chosen or designated non-acting player receives a percentage of the acting player's totaled score, determined in any chosen way, e.g., as described above.

The present invention discloses improvements to the BANANAGRAMS (trademark) game, e.g., as in certain numbered claims below, before the Abstract page.

The present invention is directed to word games with enhanced player participation in which all players have a possibility of scoring no matter who is in the process of producing a word; and even players with a limited vocabulary can win the game. This invention is directed to games in which, rather than play proceeding with an acting individual player producing a word in relative isolation, each non-acting player has the opportunity to score based on what an acting player does; and, in certain particular aspects, to a game in which each player has DESIGNATORS—individually designated game locations and/or game pieces—which, when used or accessed by any player when producing a word (e.g., making, spelling, or finding a word), results not only in a score for the person producing the word, but also in a score for the player whose game location and/or game piece is used. This invention is directed to word games with an element of chance for scoring which is not based on a player's vocabulary or a player's knowledge of words.

In certain aspects, an acting player's use of a designator is unknown to the acting player until the acting player is finished producing a word and it is only then that the acting player learns if a non-acting player gets to receive a score based on what the acting player has done.

### DESCRIPTION OF THE DRAWINGS

FIG. 1A is a back view of lettered game pieces for a first player designated by the numeral “1” and of lettered game pieces for a second player designated by the numeral “2”.

FIG. 1B shows a grid made with game pieces shown in FIG. 1A with the sides of the pieces showing with the player designation numerals showing.

FIG. 1C is a view of a grid with the lettered sides of game pieces not visible and not showing.

FIG. 1D is a view of a grid with the lettered sides of the game pieces visible and showing.

FIG. 2A is a top view of game pieces according to the present invention.

FIG. 2B is a top view of game pieces according to the present invention.

FIG. 3 is a perspective view of game pieces according to the present invention.

FIG. 4 is a top view of game pieces according to the present invention.

FIG. 5A is a top view of game pieces on a game surface according to the present invention.

FIG. 5B is a top view of game pieces on a game surface according to the present invention.

FIG. 6 is a top view of game pieces according to the present invention and game apparatus according to the present invention.

FIG. 7 is a perspective view of a game piece according to the present invention and game apparatus according to the present invention.

FIG. 8A is a cross-section view of game apparatus according to the present invention.

FIG. 8B is a cross-section view of game apparatus according to the present invention.

FIG. 8C is a cross-section view of game apparatus according to the present invention.

FIG. 9A is a top view of a game piece for a game according to the present invention.

FIG. 9B is a top view of a cover for a game piece for a game according to the present invention.

FIG. 9C is a top view of the cover of FIG. 9B on the game piece of FIG. 9A.

FIG. 10A is a perspective view of game apparatus according to the present invention.

FIG. 10B is a perspective view of a cover according to the present invention which is part of the game apparatus of FIG. 9A.

FIG. 10C is a side cross-section view of the cover of FIG. 10B.

FIG. 10D is a perspective view of a game piece that is part of the game apparatus of FIG. 10A.

FIG. 10E is a side view of the game piece of FIG. 10D.

FIG. 11A is a top view of a game according to the present invention.

FIG. 11B is a top view of a cover according to the present invention that is part of the game of FIG. 11A.

FIG. 11C is a top view of a game according to the present invention.

FIG. 11D is a top view of game pieces according to the present invention of the game of FIG. 11C.

FIG. 12A is a side cross-section view of a cover and insert combination according to the present invention for a game according to the present invention.

FIG. 12B is a side view of the insert shown in FIG. 12A.

FIG. 12C is a side view of a top cover according to the present invention.

FIG. 12D is a side view of a top cover according to the present invention.

FIG. 13A is a schematic view of a game grid for use in a game according to the present invention.

FIG. 13B is a top view of sets of indicators according to the present invention for use with the grid of FIG. 13A.

FIG. 13C illustrates a player's emplacement of indicators as in FIG. 13B in a game according to the present invention.

FIG. 13D illustrates a player's emplacement of indicators as in FIG. 13B in a game according to the present invention.

FIG. 13E illustrates a player's turn in a game according to the present invention.

FIG. 13F illustrates a player's turn in a game according to the present invention.

FIG. 13G is a top view of sets of indicators according to the present invention for use with the grid of FIG. 13A.

FIG. 13H illustrates a player's placing of indicators in a game according to the present invention.

FIG. 13I illustrates a player's placing of indicators in a game according to the present invention.

FIG. 14A is a schematic view of a game board for use in a game according to the present invention.

FIG. 14B is a schematic view of a game board for use in a game according to the present invention.

FIG. 14C is a schematic view of a game board as used in a game according to the present invention.

FIG. 14D is a top view of sets of indicators according to the present invention for use with the board of FIG. 14C.

FIG. 14E is a schematic view of a game board as used in a game according to the present invention.

FIG. 14F is a top view of sets of indicators according to the present invention for use with the board of FIG. 14E.

FIG. 15A is a top view of game pieces used in a game according to the present invention.

FIG. 15B is a top view of the pieces of FIG. 15A in a random arrangement for playing the game.

FIG. 15C shows two words produced by two different players of the game of FIGS. 15A and 15B.

FIG. 15D is a top view of the arrangement of FIG. 15B after the two turns resulting in the words of FIG. 15C.

FIG. 16A is a top view of a game according to the present invention showing two player's choices for word production in turns in the game.

FIG. 16B is a top view of the game of FIG. 16A showing further player word productions.

FIG. 16C is a front view of a game according to the present invention played on a computer according to the present invention.

FIG. 16D is a screen view of a game according to the present invention played on multiple devices according to the present invention.

FIG. 16E is a screen view of turn in the game of FIG. 16D.

FIG. 17A is a front view of a computerized game according to the present invention.

FIG. 17B is a front view of a computerized game according to the present invention.

FIG. 17C is a front view of a computerized game according to the present invention.

FIG. 17D is a front view of a computerized game according to the present invention.

FIG. 17E is a front view of a computerized game according to the present invention.

FIG. 17F is a front view of a computerized game according to the present invention.

FIG. 17G is a front view of a computerized game according to the present invention.

FIG. 17H is a front view of a computerized game according to the present invention.

FIG. 17I is a front view of a computerized game according to the present invention.

FIGS. 18A-18D illustrate a game and playing items for the game according to the present invention.

FIG. 19A is a perspective view of an electronic game piece useful in games according to the present invention. Such electronic game pieces are known in the prior art.

FIG. 19B is a top view of multiple pieces as in FIG. 19A as used in a game according to the present invention.

FIG. 20A is a perspective view of a die according to the present invention showing three faces of the die.

FIG. 20B is a perspective view of the die of FIG. 20A showing the faces not shown in FIG. 20a

FIG. 21A is a front view of a card according to the present invention.

FIG. 21B is a back view of the card of FIG. 21A.

### DETAILED DESCRIPTION OF THE INVENTION

It is within the scope of the present invention for teams of multiple players to play each other. In one aspect, all members of one team collaborate on each turn of a team. In another aspect, team members are interspersed around a game with members of other teams and each team member takes an individual turn. In one aspect, even in this situation, all team members may collaborate; but in another aspect, no team member in such a situation is allowed to communicate in any way with the team member whose individual turn it is.

It is within the scope of the present invention for a player in any game according to the present invention to earn or to win the chance to place a designator or designators. It is within the scope of the present invention for each player to have the same number of designators and for them all to be available from the beginning of the game or for them to be doled out according to a schedule as the game progresses or as a player achieves a pre-set score level.

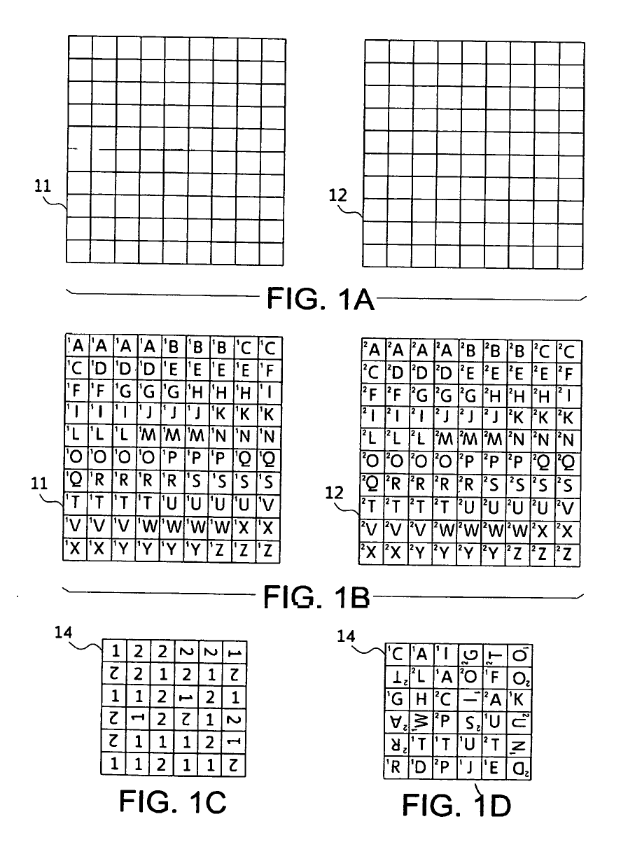

FIG. 1A shows the back sides of two sets 11 and 12 of designated game pieces. FIG. 1B shows the front sides of the game pieces of the set 11 and 12. A first player's game pieces are designated by the numeral 1 and a second player's game pieces are designated by the numeral 2.

It is within the scope of the present invention for the sets of lettered game pieces in any game according to the present invention to contain any desired number of game pieces with more or less than a whole alphabet and with one or more letters duplicated or trebled or otherwise multiplied. It is within the scope of the present invention for the sets of game pieces in any game according to the present invention to be identical or for different sets to contain different letters.

It is within the scope of the present invention for any desired number of players to play a game. It is within the scope of the present invention for the lettered game pieces to have letters or pictographs of any language and for a game according to the present invention to be played using any language. The previous aspects mentioned in this paragraph can be aspects of a game played with the lettered game piece sets of FIG. 1A.

Optionally a grid can be made of lettered game pieces with all the lettered value pieces of FIG. 1A or, e.g., see FIG. 1C or FIG. 1D, to use less than all the game pieces of a set.

As shown in FIG. 1C, in one aspect, initially chosen game pieces are placed face down to form a grid. This can be done with the lettered game pieces being face down from the start of play until they are placed as in FIG. 1B; with the pieces being face up and known to all players; with each individual set known to the designated player whose set it is before placement; each set known only to one other player (e.g., for a first player the first player's set before placement is known to the only other player if there are two players or to another player to the left of the first player); or sets are known to all players except the designated player for a set. Pieces can be placed by the player whose pieces are designated; or by another or other players—with the pieces letters face up and known the player placing them or not.

In one aspect, using the sets of FIG. 1A, there are two players each with one of the designated lettered game piece sets and at the beginning of play all pieces are face down and unknown to both players. The player whose designated set is the set with the numeral “1” (the “first player” with the “first set”) chooses at random six pieces from the set of the other player, the set with the numeral “2” (the “second player” with the “second set”). The first player then places the chosen six pieces face down forming part of a grid 14 (see FIG. 1C). The second player then chooses at random six pieces from the second set and places them face down in the remaining spaces between or adjacent the pieces from the first set to form the grid of FIG. 1C. Then the pieces are turned face up so the letters are visible to both players (see FIG. 1D).

Alternatively, all pieces in the grid 14 are face up from the beginning of the game. Alternatively, each player chooses the pieces to form the grid, with the pieces either known to the player during choice and placement or unknown. Alternatively, the pieces are placed by the player whose pieces they are, but they are unknown when chosen and then known before placement. Alternatively, the grid has more or less pieces than the grid 14.

Once the grid 14 is formed, the first player views the grid 14 and takes a first turn to produces a word. In one aspect, the word is produced by using letters that are next to, diagonal from, or adjacent another letter, all in any direction. For example, the first player produces the word “catch” which uses the letters “a,” “t;” and “h” (designated with the indicator “1”) from the first player's set and the letters “c” and “c” (each designated with the indicator “2”) from the second players set. The first player gets a score for producing the word. The second player also gets a score because the first player used the letters “c” and “c” from the second player's set.

Any desired scoring system may be used for a first player for producing the word and for a second player due to the use of letters from the second set used in the produced word made by the first player (as is true for any embodiment hereof). For example, and not by way of limitation, in the first turn described above, the first player receives ten points no matter what word is produced and no matter how many letters are used to produce the word; and the second player receives a point for each letter of the second set used in the first player's word—i.e., in this instance, the first player gets ten points and the second player (a non-acting player) gets two points. Alternatively, the first player receives a score of five points which corresponds to the number of total letters in the produced word; and the second player receives a flat two points no matter how many letters from the second set are used by the first player.

Other scoring options include: assigning set scores to words made by a first player, using different numbers of letters, in one aspect with scores increasing as the number of letters increases; and, for the second player, a score based on the number of letters used from the second set, in one aspect with scores increasing as the number of letters used from the second set increases.

Following the first turn by the first player, the second player views the grid 14 and produces a word, different from the first player's first word, using the letters visible in the grid 14. The second player receives a score for this new word, as does the first player if the second player uses any of the lettered game pieces from the first player's set of game pieces. Whatever scoring system is agreed on and was used for the first player's turn is used for all subsequent turns.

Play proceeds with each player taking a turn and with a score given for each new word that is produced, with players accumulating a total score based on all the scores for individual words produced. Play can cease at any agreed point; e.g., after a set time period has expired, after an agreed-upon number of turns for each player, or after one player has reached an agreed-upon total score.

Optionally, a player may receive a pre-set bonus for producing a word using only game pieces from that player's designated set of game pieces. Optionally, such a bonus is awarded only for a word that uses an agreed-on number of letters.

Optionally, (and as is true for any game according to the present invention) any player may challenge a word produced by another player and an authority, agreed upon before play commences, is consulted to see if the challenged word is indeed a word. It is within the scope of the present invention for the players to agree before play commences: that there is a scoring penalty assessed against a player who challenges a produced word that is indeed a word according to the authority; that there is no such penalty; and/or that each player in any game or in any set period of a game gets a set number on non-penalty challenges. It is within the scope of the present invention for the players to agree to any acceptable authority e.g., but not limited to, a living person, a dictionary, or a word database accessible via the Internet.

In one aspect, the grid 14 is the only grid used for a complete game. In other aspects, after a series of turns or as agreed upon, another grid is formed as the first grid 14 was formed and play goes on with the new grid.

In another aspect, multiple subsequent grids are formed and played until the game is completed. A grid made after the grid 14 may be made again using all the pieces of a lettered game piece set, including the pieces that were used in the grid 14; or the pieces used for the grid 14 are discarded and a new grid is made with remaining game pieces (the pieces from the game piece sets not used in the grid 14). Subsequent grids, if any, may be made with all the game set pieces or only with pieces that have not yet been used in a grid.

Optionally, each time a round of turns has been completed (i.e., when each player has completed a turn; e.g., when there are two players and each of them has completed a turn), all pieces (and only those pieces) used by the players in producing their words are removed from the grid or are turned over face down and cannot be used again.

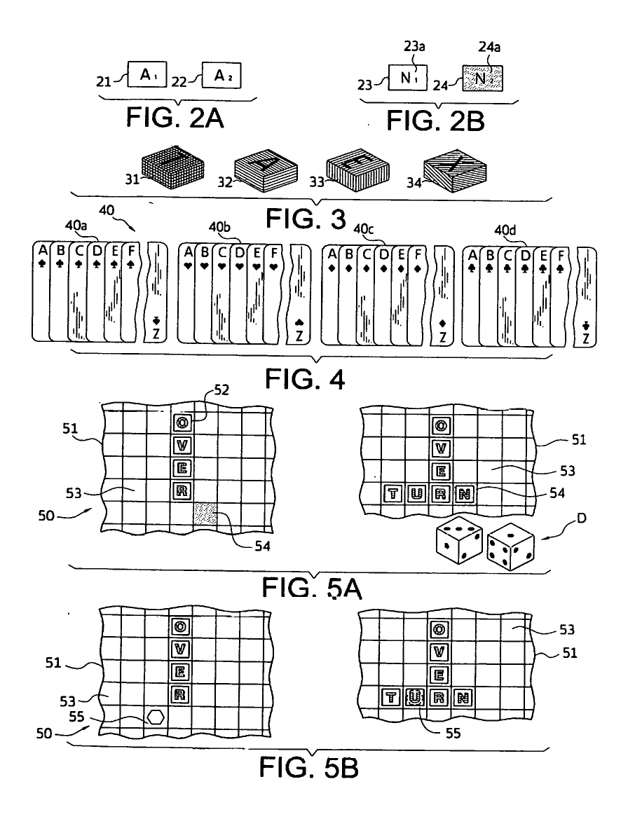

As shown in FIG. 2A game pieces designated for different players can be designated using numerals. A piece 21 bearing the numeral “1” is a piece designated for a first player and a piece 22 bearing the numeral “2” is designated for a second player.

As shown in FIG. 2B, a piece 23 designated for a first player has a white color 23a and a piece 24 designated for a second player has a gray color 24a. Optionally, and piece or location can have two or more designators; for example, the piece 23 may also have the designating numeral 1 and the piece 24 may also have the designating numeral 2.

FIG. 3 shows lettered game pieces 31, 32, 33, and 34 each with a different indicator indicating a different player. The indicators used for the game pieces 31-34 are visually different lining on the game piece. Each player's set of game pieces has the identical lining so that each pieces is identifiable as a particular player's piece. As is true for any embodiment hereof, in any set of pieces not all pieces are designated for a particular player.

FIG. 4 illustrates the use of symbols or shapes as player indicators. Cards 40 (which are, alternatively, pieces or tiles) may have a letter used in a word game and a symbol indicator (or shape) . Cards 40a each bear a letter for use in a word game and a spade symbol. Cards 40b each bear a letter for use in a word game and a heart symbol. Cards 40c each bear a letter for use in a word game and a diamond symbol. Cards 40d each bear a letter for use in a word game and a club symbol. Any desired number of cards may be used for each player, with or without duplicating or trebling or multiplying any letter or every letter.

It is within the scope of the present invention for any game pieces to be designated as are the cards in FIG. 4. It is within the scope of the present invention for any game location, e.g., on a board, on a game surface, on a game apparatus, to be designated with the shape indicators as are the cards in FIG. 4. It is within the scope of the present invention for all the cards to be designators or for only some of them to bear indicators.

FIG. 5A illustrates the use of a game board 51 in a game 50 according to the present invention in which words are produced on the game board 51 by placing lettered pieces or tiles 52 on parts of a grid 53 on the game board 51. In one aspect the game 50 is a ROLL 'EM (Trademark) game according to the present invention. The game board 51 is first shown with the word “over” already formed on the game board 51. A square 54 of the grid 53 is designated for a specific player P by the gray color of the square 54. When a player other than the player P places a lettered tile on the square 54 in making a word, the other player making the word receives a score and the player P also receives a score.

As shown with the making of the word “turn” by a player other than the player P, the word “turn” has the letter “n” on the square 54. Therefore, the player P also receives a score when the other player makes the word “turn.”

In FIG. 5B, the game board 51 is shown 51b with the word “over” already formed on the game board 51. A square 55 of a grid 56 is designated for a specific player L by the hexagon symbol on the square 55. When a player other than the player L places a lettered tile on the square 55 in making a word, the other player making the word receives a score and the player L also receives a score. For example, and not by way of limitation, if a player N makes the word turn, the player N receives 4 points for producing this word and the player L receives 1 point due to the player N's use of the designator 55 (the game location designator with the hexagon symbol of the player L).

As shown with the making of the word “turn” by a player other than the player L, the word “turn” has the letter “u” on the square 55. Therefore, the player L also receives a score when the other player makes the word “turn.”

In one scoring option for games according to the present invention, when a designator has an indicator that designates a first player, and a second player uses the first player's designator, the second player receives a second score and the first player receives a first score for the use by the second player of the first player's designator (e.g., a game piece or a location).

In another option, the first player receives an additional score if the first player is the first to use the first player's designator. For example, the first player receives a score, e.g. one point, but the additional score may be 1, 5, 10 or more points; i.e., in one aspect, it is to the advantage of the first player to be the first one to use the first player's designator and it is in the interest of the other players to use the first player's designators before the first player does so-and so for all player's designators.

For example, in an example based on the embodiments described above for the game using the game board 51, if the player P is the player who makes the word “over,” then the other player who makes the word “turn” prevents the player P from receiving the increased score for being the player to use the square 54. In another example, assume that a player Q has made the word “over” (as in FIG. 5A) and that if any player, other than the player P, makes a word using the square 54, the player P gets one point. But, assume further that it is the player P who makes the word “turn” which uses the square 54. The player P gets a word score and an additional score, e.g. an additional ten points, for using the square 54.

With such scoring possibilities, the other players must take into account the consequences of their not using another player's designators before the designated player does so. In the example above, the other players must consider using (“getting to”) the square 54 before the player L does.

Optionally, the game 50 includes a chance number generator, for example, and not limited to a die or dice (e.g., the disc D shown in FIG. 5A) . When the acting player produces a word with a non-acting player's designator, the dice are thrown and the numbers showing on the dice are added together. This sum is used as described above to be or to serve in calculating a designator score for the non-acting player.

For example, in the example given above for the turn indicated in the FIG. 5B in which the word “turn” was produced and the player N received 4 points, the dice are thrown and, as shown in FIG. 5A, the up faces of the dice have the numbers 3 and 1. The sum of these numbers is 4 and the player L (the non-acting player whose designator was used) receives 4.times.4=16 points. Alternatively, the player L receives 4 points (the sum of the two numbers).

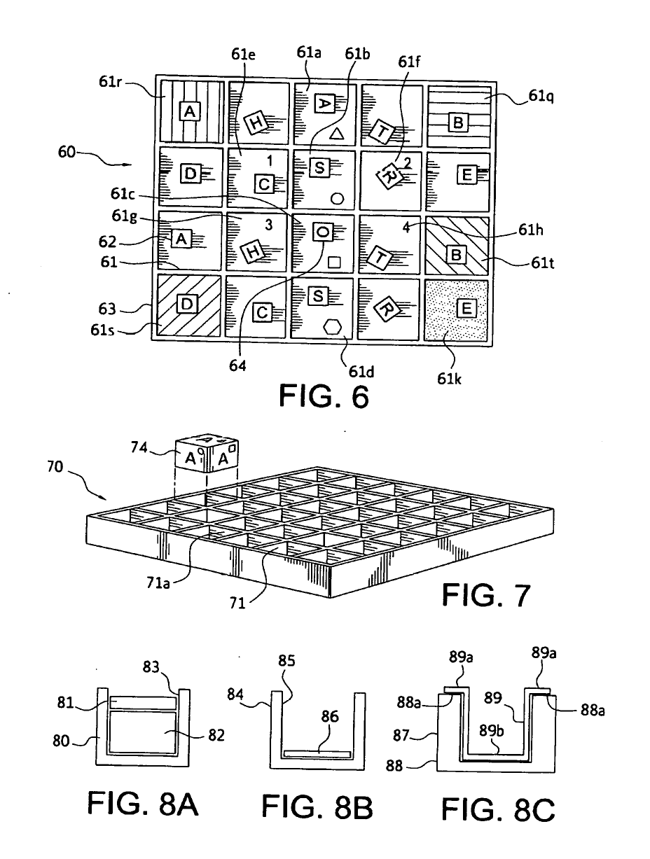

FIG. 6 illustrates a game 60 according to the present invention in which game pieces 62 are located-randomly by chance or as placed by game players, with letter faces up or down—in individual compartments 61 of a container 63. FIG. 6 illustrates a variety of possibilities of indicators for designators for designating game pieces and/or game locations as those of a particular player. It is within the scope of the present invention to use any indicator according to the present invention with any piece or location of the game 60.

For example, a game piece 64 with the letter “o” is colored gray to designate a particular player. One, some, or all faces of the piece 64 may be so indicated.

Each compartment 61 is a game location in which a lettered game piece is placed. In one aspect, certain compartments are designated for different players, e.g., for four different players, one compartment for each player. For example, the compartments 61a-61d each has a different shaped FIG. to designate the compartment. For example, the compartments 61e-61h have different numerals to designate different compartments. For example, compartments 61q-61t have different lining to indicate different compartments. It is also within the scope of the present invention to use color to indicate different designated compartment. For example, a compartment 61k colored gray (this compartment is shown with a game piece with the letter “e”) indicates a specific player.

FIG. 7 illustrates a game 70 according to the present invention in which game pieces are located—randomly by chance or as placed by game players-in individual compartments 71 of a container 73. It is within the scope of the present invention to use any indicator according to the present invention with any piece or location of the game 70. The game piece 74 is to be placed in one of the compartments 71.

For example, the game piece 74 with the letter “a” on each of its six faces has a different player designator on each of these faces. As shown, three faces are shown with different symbol designators-circle, square, triangle—to designate three different particular players. As with the game 60, compartments 71 can also be designated for a particular player. A compartment 71a bears a triangle indicator. It is within the scope of the present invention, in the games 60 and 70, to designate one, some, or all of the compartments and/or pieces for particular players.

It is within the scope of the present invention for a player who both plays a game piece designated for that player in a game location designated for that player to receive an extra score amount. For example, in one aspect, if the game piece 74 in FIG. 7 is played by the player designated by the triangle symbol in producing a word in the game 70, and the game piece 74 is placed in the compartment 71a which is marked with the same triangle symbol designation, this player receives an extra score in addition to any other score for producing the word, for example, extra points (e.g., ten twenty, thirty, fifty, a hundred or more extra points) or the player receives an additional score which is the score for the produced word multiplied by a multiplier, e.g., two, three, five, ten or more. This creates added incentive for other players to use the compartment 71a in their turns and it adds to the strategy of where a player plays so that access to compartment 71a is hindered or denied to the player designated by the triangle symbol.

It is within the scope of the present invention for the scoring described in the preceding paragraph to be used in any game according to the present invention and for any game according to the present invention to have the aspects of designated game pieces and designated game locations.

Scoring in the game 60 or in the game 70 can be based on finding words in a grid of letters showing on the face of lettered game pieces in the compartments of the containers 63, 73, respectively. Alternatively, scoring can be based on players producing words by placing lettered game pieces in compartments of game apparatus containers.

Scoring in the game 60 or in the game 70 can be based on words made by players producing words by placing game pieces in a grid in the compartments of the containers 63, 73, respectively. Players may place lettered game pieces in order with each player beginning with the same number of game pieces, with game pieces chosen randomly or chosen knowingly. In one aspect, players either make a word with a pre-set number of game pieces for which they receive a score, or, if they make no word, they still must place the same pre-set number of game pieces in compartments. In one aspect, if a player places game pieces and a word is produced that that player does not realize has been made, any subsequent player may claim that word and its accompanying score; and, in one aspect, such a player also can then proceed with a regular turn (as is true for any embodiment hereof).

Scoring in the game 60 or in the game 70 can be based on words made by players producing words by placing game pieces in a grid face-up lettered pieces in the compartments of the containers 63, 73, respectively; and then further scoring in the game 60 or in the game 70 can be based on finding words in the grid of letters previously made by the players.

FIG. 8A shows a game apparatus 80 according to the present invention which provides a way for a player to designate a game location or a game piece as that particular player's designated game piece or game location. A transparent cover 81 is placed on a lettered game piece 82 and from the time the cover 81 is emplaced over the game piece 82, the game piece 82 is designated as that players designated piece. The piece may be a piece not yet played, or it may be a piece, as shown in FIG. 8A, which has been played in a compartment 83. The cover 81 bears a player's indicator or is an indicating color (any indicator disclosed herein).

Optionally, the only time a player can place that player's designated cover on a game piece is when that player in a turn of play produces a word with that game piece. Optionally, the only time a player can place that player's designated cover on a game piece is when that player in a turn of play places the cover on a game piece, which may be any game piece on the grid, whether or not that player produced the word that contains that game piece.

In one aspect, the game piece 82 (or any game piece shown herein in a compartment or described herein for placement in a compartment) is a game piece in a compartment of a container of a game; e.g., but not limited to, a game like the games 60 and 70, or the BOGGLE (Trademark) game.

It is within the scope of the present invention to use a cover to designate a game location as the designated location of a particular player by placing a cover on the game location. For example, a designating cover can be placed on a square on a board (or surface) used in a word game; on a letter location in a grid of letters which is to be searched for words existing therein (either on the location before the letters are entered or after); or on a bottom of a compartment of a container used in a word game. The options for the timing of the placement of a cover on or at a game location are the same as stated above for the placing of a cover on a game piece.

According to the present invention, a cover (e.g, the cover 81) may provide designation by its color and/or by a designator, symbol or other indicia on the cover.

FIG. 8B shows an apparatus 84 according to the present invention that includes a compartment 85 into which a lettered game piece may be placed or may fall. An insert 86 fits into the compartment so that a game piece can be placed on top of it. The insert 86 is an indicator or has an indicator indicating a particular player of the game; i.e. the insert 86 serves to make the compartment into a designator, a designator of the game location of the compartment 85.

FIG. 8C shows an apparatus 87 according to the present invention that includes a compartment 88 into which a lettered game piece may be placed or may fall. An insert 89 fits into the compartment so that a game piece can be placed on top of it. The insert 89 is an indicator or has an indicator indicating a particular player of the game; i.e. the insert 86 serves to make the compartment into a designator, a designator of the game location of the compartment 88.

The insert 89 has shoulders 89a (or a shoulder 89a) which extend over edges 88a of the compartment 88. The shoulders 89a may bear an indicator or include an indicator so that, even with a game piece in the compartment 88, the shoulders are visible and the designation status of the compartment is still evident. Optionally, a bottom 89b of the insert 89 is deleted. Optionally, the bottom 89b is an indicator or bears an indicator.

The insert 89 may be placed into the compartment 88 according to any method, sequence, or manner disclosed herein for the placement or play of an indicator or designator according to the present invention. Optionally, the insert 89 is randomly emplaced in a compartment; or it is allowed to fall into a compartment by chance.

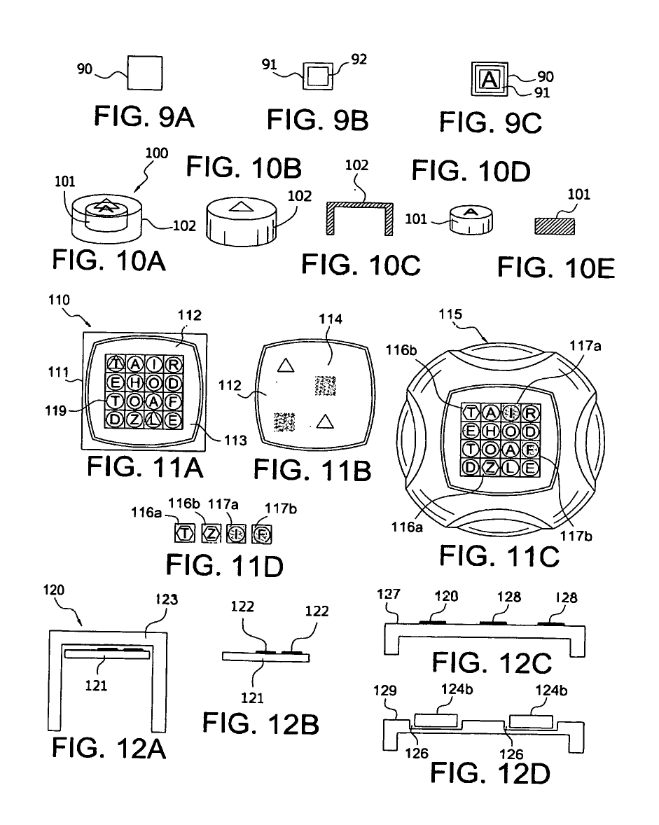

FIG. 9A shows a lettered game piece 90. FIG. 9B shows a transparent cover 91. The cover 91 bears as an indicator a square symbol 92. FIG. 9C shows the transparent cover 91 on the game piece 90.

FIG. 10A shows a game apparatus 100 according to the present invention that includes a lettered game piece 101 (see FIG. 10D) within a transparent cover 102 (see FIG. 10B) that designates a particular player. Any indicator can be used with the cover 102; for example, as shown the cover 102 has a triangle symbol thereon.

It is within the scope of a game according to the present invention for a container of lettered game pieces to have a transparent top through which game pieces are viewable with the top having indicator(s) thereon or with an insert for the top that has indicators thereon so that a lettered game piece viewed through the top and through the indicator is designated as the game piece of a particular player; and/or it is within the scope of a game according to the present invention for a container of lettered game pieces to have a transparent top through which game locations are viewable with the top having indicator(s) thereon or with an insert for the top that has indicators thereon so that a game location viewed through the top and through the indicator is designated as the game location of a particular player.

Certain prior BOGGLE (Trademark) games known heretofore have a transparent top member through which game pieces in a lower container can be viewed (and which in some aspects is removed for play). One example of such a prior game is disclosed in U.S. Pat. No. 8,002,280—incorporated fully herein for all purposes.

FIG. 11A shows an improved BOGGLE (Trademark) game 110 according to the present invention which has a container 111 for game pieces 119 and a transparent cover 112 through which lettered game pieces may be viewed. It is within the scope of the present invention for the cover 112 to be permanently or semi-permanently connected or adhered to the container 111; or for the cover 112 to be removably securable to the container 111.

In one aspect, the cover 112 is releasably secured to the container 111 while game pieces are allowed to fall into or enter individual piece compartments 113 of the container 111 and then game locations are viewed through the cover 112 to see which game locations are designated by indicators on the cover 112; and then the cover is removed for play. In another aspect, even if the cover is removable, it remains over the game pieces during play. In another aspect, either game pieces are placed into a container by chance and/or at random or players place game pieces in the container, and then the cover is placed over the container at which time the players learn the game location designators created by the use of the cover. In another aspect, the cover is not placed over the lettered game pieces until all players have ceased finding words (and/or at a point at which allotted time has expired)—at which point the cover is placed over the lettered game pieces and also at which point operative game designators are created that affect the scoring of the words.

The cover 112 as shown in FIG. 11B has a transparent pane 114 on which are indicators for designating locations for two players. A triangle symbol designates two locations for a first player and a color gray (through which game pieces can be viewed) designates two locations for another player. As shown in FIG. 11A, a letter “t” and a letter “l” are designated for the first player and a letter “d” and a letter “o” are designated for the second player.

FIG. 11C shows an improved BOGGLE (Trademark) game 115 according to the present invention in which several individual game pieces (see FIG. 11D) are designators for particular players. Game pieces 116a and 116b bear a hexagon symbol for designating a first player and game pieces 117a and 117b bear a color gray for designating a second player.

FIG. 12A shows a game apparatus 120 according to the present invention which has a transparent top 123 for covering game pieces and/or game locations used in a word game and an insert 121 viewable through the top 123. The insert 121 (see FIG. 12B) has an indicator 122 or indicators 122 or a portion or portions thereof are made of an indicating color.

It is within the scope of the present invention to provide a plurality of different inserts like the insert 121 (or like the other inserts described above) so that at different stages or turns of a game a different insert is used resulting in different designators.

It is within the scope of the present invention to provide an exterior cover for a top that covers game pieces. As shown in FIG. 12C, a cover 127 according to the present invention is sized and configured so that it fits over a top like the top shown in FIG. 12A (or like any top used with any known word game, including, but not limited to any top used with any BOGGLE (Trademark) game)). The cover 127 bears one, two, or more indicators 128 (or a transparent portion or portions are made of an indicating color) so that game location(s) and/or game pieces viewed through the cover 127 are designators for a particular player.

In another embodiment, as shown in FIG. 12D, a cover 129 has recesses 126 and indicator members 124a and 124b (each with an indicator, for making a designator or designators for each player) are placed in the recesses 126. A plurality of members 124 may be provided so that the cover 129 may be changed so that, at different times in a game, different designators are created. Such a structure with recesses may be used with the insert 121 (or with any cover or insert described herein).

It is within the scope of the present invention to provide a plurality of different covers like the cover 127 (or like the cover 129 or like other covers described above) so that at different stages or turns of a game a different cover is used resulting in different designators.

An insert according to the present invention (e.g., such as the inserts in FIGS. 8A-8C, and 12A) may be placed for play in any game according to the present invention according to any method, sequence, or manner disclosed herein for the placement or play of an indicator or designator according to the present invention.

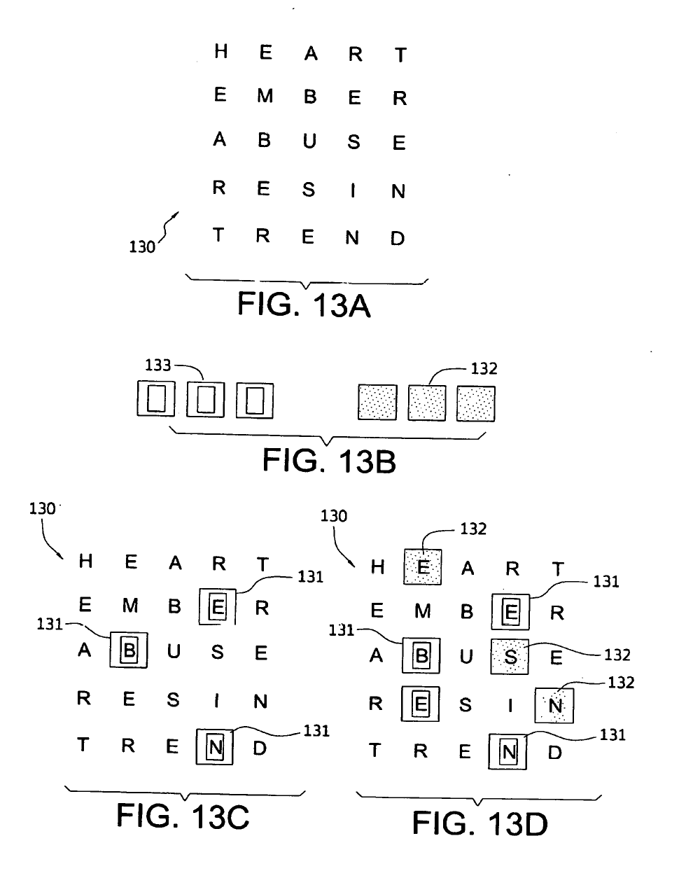

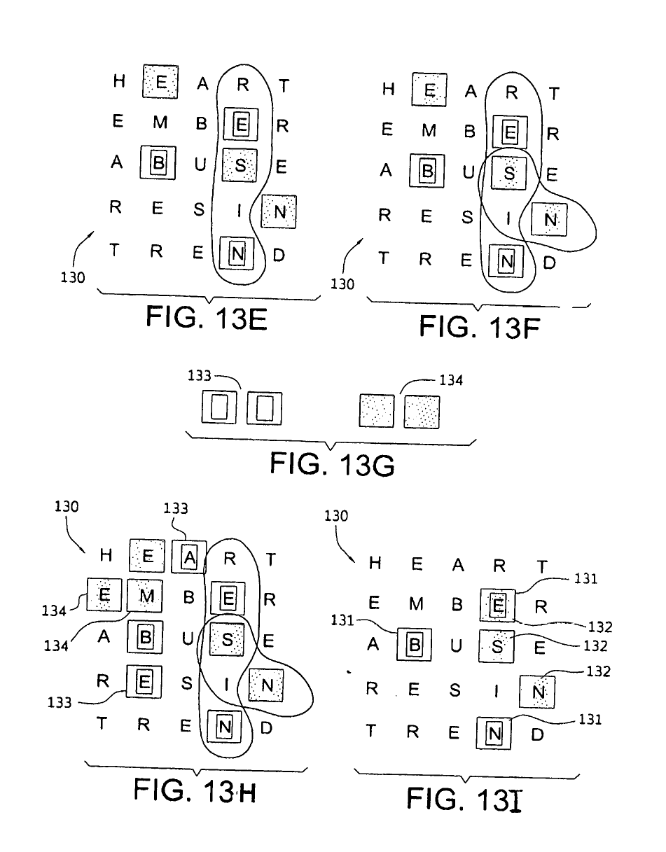

FIG. 13A shows a game grid 130 for a DOUBLE TROUBLE (Trademark) word search game according to the present invention. As shown in FIG. 13B, a first player has three indicators 131 and a second player has three indicators 132. These indicators are transparent plastic members. The indicators 131 have a rectangle symbol and the indicators 132 have a gray color. The indicators are sized for placement over a letter of the game grid shown in FIG. 13A. Any random or non-random letter grid may be used for the grid 130 and any number of letters may be used for the grid.

Before the first player produces a first word, each player chooses three letters over which to place the indicators. As shown in FIG. 13C, the first player has placed the indicators 131 over the letters “e,” “b,” and “n.” Then the second player chooses over which letters to place the indicators 132. As shown in FIG. 13D, the second player has placed the indicators 132 over the letters “e,” “s,” and “n.” Now play commences with the first player's attempt to produce (in this case, find a word in the game grid) a first word for a score.

The letters “e,” “b,” and “n” with the first player's indicators thereon are now designators for the first player; and the letters “e,” “s,” and “n” with the second player's indicators thereon are now designators for the second player.

As shown in FIG. 13E, the first player finds the word “resin” which results in a score of 12 points for the first player. This 12 point score represents 10 points for making a five-letter word and 2 points for using the first player's “e” and “n” designators.

As shown in FIG. 13F, the second player has used the next turn to find the word “sin.” The second player receives a 10 point score for this word—8 points for making a three-letter word and 2 points for using the first player's designators “s” and “n.”

Play progresses with each player in turn finding new words and accumulating a total score. Play continues until a pre-selected total score is achieved by one of the players or until a pre-set time period expires. Optionally, and as is true for any game according to the present invention, after a pre-selected time or number of turns, each player receives an additional indicator or additional indicators to use to create new player designators. For example, as shown in FIG. 13G, the first player receives two new indicators 133 and the second player receives two new indicators 134. As shown in FIG. 13H, these are used after the players have completed one turn each.

As shown in FIG. 13H, the first player has made additional designators for the letters “e” and “a;” and the second player has made additional designators for the letters “e” and “m.”

Optionally, and as is true for any game according to the present invention in which players make their own designators by their own choice of game location(s) and/or game piece(s), a second player can choose to negate a designation already made by another player by “taking over” that designator by placing an indicator of the second player on the already-placed indicator. For example, as shown in FIG. 13I, the second player, after the first player has placed the first three indicators 131, has nullified the creation of the first player's effort to make a letter “e” a first player designator by placing a second player indicator 132 over the already-placed indicator 131 of the first player. It is within the scope of the present invention for such a placement of an indicator that nullifies a previously-placed indicator to result in that letter being no player's designator, i.e., it is as if no player has placed an indicator on that letter; or such a letter can then be the designator of the last player to place an indicator on that letter.

It is within the scope of the present invention in any game according to the present invention for any number of designated game pieces to be used and/or for any number of designated game locations to be used; and for them to be randomly assigned or chosen by a player who will be thereby designated or by a player who will not be designated thereby.

In one aspect, when play begins there are no operative designators; but each player has one indicator member or a plurality of indicator members and each player has an option or options to play (place on a location or cover a game piece) an indicator as the game progresses. This option or these options include nullifying a previously-played indicator by either removing the previously-played indicator or by placing an indicator over the previously-played indicator. In one aspect, a player may play an indicator during any turn and in another aspect, players may only play an indicator during specified turns, e.g., every third or fourth turn.

In one aspect, if there is a designator that did not come into existence because of the chosen placing of an indicator by a player during the course of a game, for example if there is a designator that was created at the start of the game by the nature of a cover or insert, such a designator may be changed by a player who chooses to nullify the original designation by placing an indicator at or over the original designator.

In one aspect, in a game according to the present invention in which each player has a plurality of indicators that can create a designator for each player, a player may create an enhanced designator by—in successive turns or in different turns—placing a second indicator on or at a previously-played first indicator. Such an attempt may be thwarted, in one embodiment, if another player has placed an indicator on the first indicator before the player places the second indicator.

It is within the scope of the present invention for teams of multiple players to play each other. In one aspect, all members of one team collaborate on each turn of a team. In another aspect, team members are interspersed around a game with members of other teams and each team member takes an individual turn. In one aspect, even in this situation, all team members may collaborate; but in another aspect, no team member in such a situation is allowed to communicate in any way with the team member whose individual turn it is.

It is within the scope of the present invention for a player in any game according to the present invention to earn or to win the chance to place a designator or designators. It is within the scope of the present invention for each player to have the same number of designators and for them all to be available from the beginning of the game or for them to be doled out according to a schedule as the game progresses or as a player achieves a pre-set score level.

It is within the scope of the present invention for the sets of lettered game pieces in any game according to the present invention to contain any desired number of game pieces with more or less than a whole alphabet and with one or more letters duplicated or trebled or otherwise multiplied. It is within the scope of the present invention for the sets of game pieces in any game herein to be identical or for different sets to contain different letters.

It is within the scope of the present invention for any desired number of players to play a game. It is within the scope of the present invention for the lettered game pieces to have letters or pictographs of any language and for a game according to the present invention to be played using any language. The previous aspects mentioned in this paragraph can be aspects of a game played with the lettered game piece sets of FIG. 1A.

It is within the scope of the present invention to make a grid of lettered game pieces with all the lettered game pieces provided or to use less than all the game pieces of a set.

Optionally, a player may receive a pre-set bonus for producing a word using only game pieces from that player's designated set of game pieces. Optionally, such a bonus is awarded only for a word that uses an agreed-on number of letters.

Optionally, (and as is true for any game according to the present invention) any player may challenge a word produced by another player and an authority, agreed upon before play commences, is consulted to see if the challenged word is indeed a word. It is within the scope of the present invention for the players to agree before play commences: that there is a scoring penalty assessed against a player who challenges a produced word that is indeed a word according to the authority; that there is no such penalty; and/or that each player in any game or in any set period of a game gets a set number on non-penalty challenges. It is within the scope of the present invention for the players to agree to any acceptable authority e.g., but not limited to, a living person, a dictionary, or a word database accessible via the Internet.

In one scoring option for games according to the present invention, when a designator has an indicator that designates a first player, and a second player uses the first player's designator, the second player receives a second score and the first player receives a first score for the use by the second player of the first player's designator (e.g., a game piece or a location).

In another option, the first player receives an additional score if the first player is the first to use the first player's designator. For example, the first player receives a score, e.g. one point, but the additional score may be 1, 5, 10 or more points; i.e., in one aspect, it is to the advantage of the first player to be the first one to use the first player's designator and it is in the interest of the other players to use the first player's designators before the first player does so—and so for all player's designators.

The present invention, in certain embodiments, provides improvements to the SCRABBLE (Trademark) game which make it possible for a second player to be awarded a score when a first player who makes a word by placing tiles on the board receives a score. The second player receives a score if the first player in making a word on the board places a lettered tile on a game location designator of the second player; if the first player, in making a word, uses a lettered tile designator of the second player that has already been placed on the board in a previous board; or both.

The present invention, in certain embodiments, provides improvements to the well-known SCRABBLE (Trademark) word game. In the SCRABBLE (Trademark) word game, one player at a time takes a turn and makes a word with one or more lettered tiles. Words are made by placing the tiles on a SCRABBLE (Trademark) board. No other player can score when another player makes a word.

The present invention, in certain embodiments, provides improvements to the SCRABBLE (Trademark) game which make it possible for a second player to be awarded a score when a first player who makes a word by placing tiles on the board receives a score. The second player receives a score if the first player in making a word on the board places a lettered tile on a game location designator of the second player; if the first player, in making a word, uses a lettered tile designator of the second player that has already been placed on the board in a previous board; or both.

In one aspect, the present invention provides a board for a SCRABBLE (Trademark) game which has on it, before play commences, one or more game location designators for each player.

In one aspect, the present invention provides an improved SCRABBLE (Trademark) game which has on the board, before play commences and/or as play progresses, one or a plurality of two or more game location designators for each player. These designators are placed on the board by the players. They may be placed on the board in any manner disclosed herein for the placement of game location designator(s) and any suitable indicator disclosed herein may be used to effect a game location designation.

In one aspect, the present invention provides an improved SCRABBLE (Trademark) game which has a designated lettered tile or tiles for each player. The tile or tiles may be played in any suitable manner described herein for the playing of a lettered game piece. Any suitable indicator disclosed herein may be used with a lettered tile to make it a lettered tile designator.

In one particular aspect of an improved SCRABBLE (Trademark) game according to the present invention, designated tile(s) are provided for each player before play commences. Any desired number of game tile designators may be provided for each player; e.g., one or a plurality of two or more such tiles, and, in one aspect, a complete alphabet of designators is provided for each player.

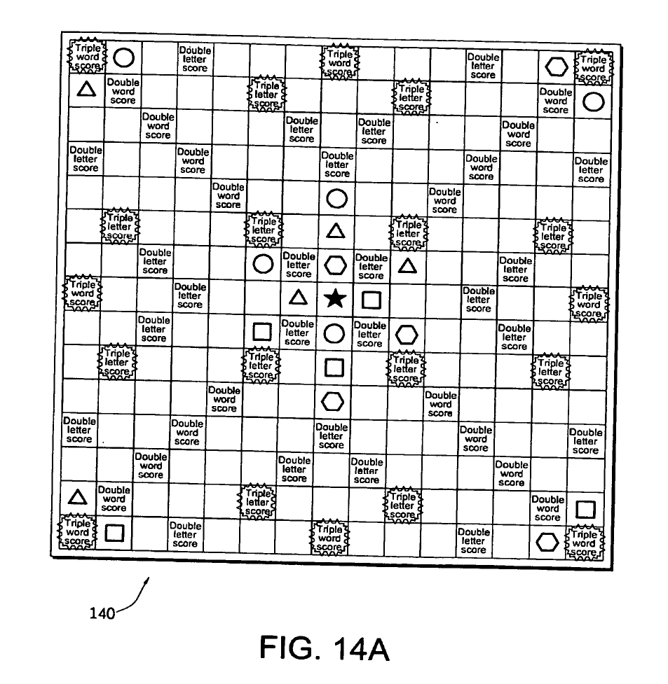

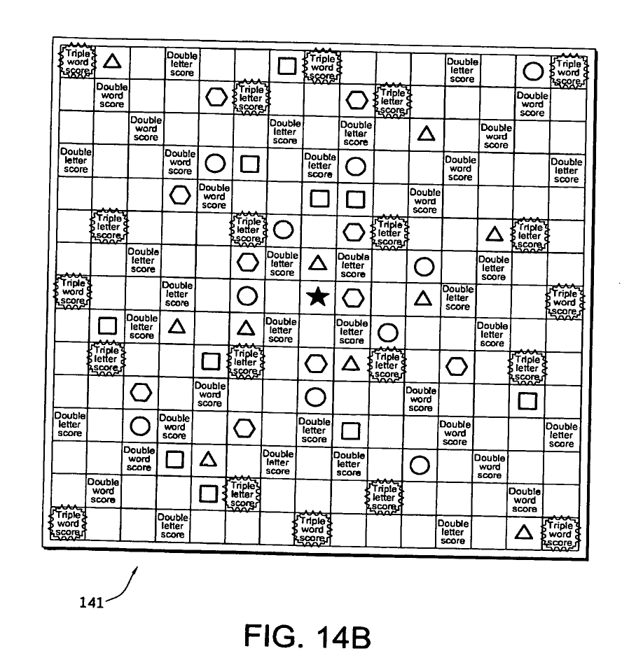

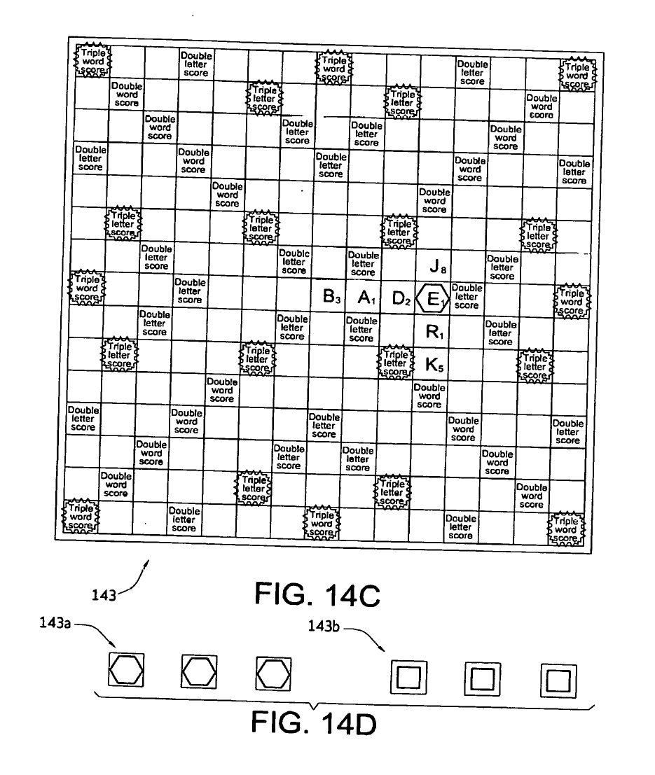

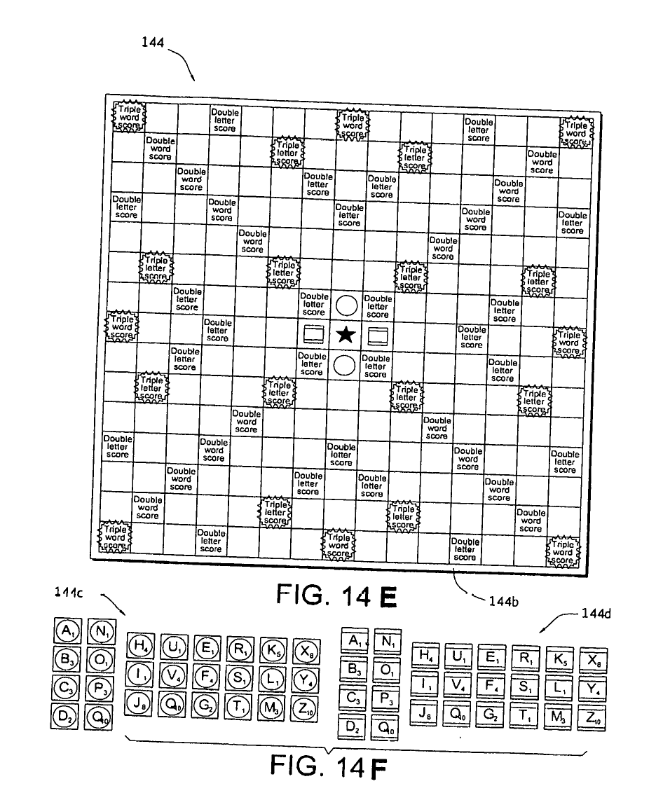

FIG. 14A shows a board 140 according to the present invention for playing an improved SCRABBLE (Trademark) game according to the present invention. A plurality of game location designators are on the board before play commences. As shown, each of four players has 5 game location designators, each set of which is indicated by a different geometric shape symbol (square, triangle, circle, and hexagon).

It is within the scope of the present invention for the game location designators to be pre-printed on the board 140 (as shown in FIG. 14A) or for them to be created before play commences with suitable indicators; for example, but not limited to, transparent indicators each of which covers a game board letter tile location. In such a game, the location of the game location designators is pre-established and the players have no discretion in where the indicators are placed.

FIG. 14B illustrates an improved SCRABBLE (Trademark) game 141 in which, before play commences, each player is provided with indicators for placement on the board for designating player game location designators. It is within the scope of the present invention for these indicators to be placed on the board periodically as play progresses; or, as shown in FIG. 14B, all the indicators may be placed on the board before play commences.

In one aspect, indicators are placed with each individual player placing all of that players indicators on the board at one time. A board as shown in FIG. 14B may be created in this way. For example, the player designated by the square symbol places all of these indicators on the board at one time. Then a next player, e.g., the player whose indicators bear the triangle symbol, places all those indicators on the board, and so forth for the other players.

The order of players taking turns to place their tiles may be determined by chance; e.g., by rolling a die or with a coin flip or coin flips.

FIGS. 14C and 14D illustrate an improved SCRABBLE (Trademark) game 143 according to the present invention in which, before play commences, each player receives a set of individual indicators which, during play, are implacable on a lettered tile game piece. As a player places tiles on the board to make a word, that player may, at that player's discretion, place one or more indicators on one or more tiles being played by that player; thus creating for a tile on which an indicator is placed a game piece designator for that player.

As shown in FIG. 14D, for example, each of two players receives a set 143a or 143b of game piece indicators (set 143a bears a hexagon symbol; set 143b bears a square symbol). As shown in FIG. 14C, a first player made the word “bade” and placed an indicator on the letter “e.” When the second player makes the word “jerk” using the first player's designated tile “e,” the first player receives a score. Any suitable method disclosed herein for determining the amount of the score for the second player may be used.

FIGS. 14E and 14F illustrate an improved SCRABBLE (Trademark) game 144 according to the present invention in which a board 144b has game location designators and each player has designators that are a set of lettered tile game pieces. The board 144b bears two game location designators for a first player (bearing a circle symbol) and bears two game location designators for a second player (bearing double parallel lines). As shown in FIG. 14F, the first player has a set 144c of lettered game pieces that are each a designator for the first player (each marked with the circle symbol); and the second player has a set 144d of lettered game pieces that are each a designator for the second player (each marked with the double parallel line marking). As each tile of each set is placed on the board during play, each tile is a game piece designator for the indicated player.

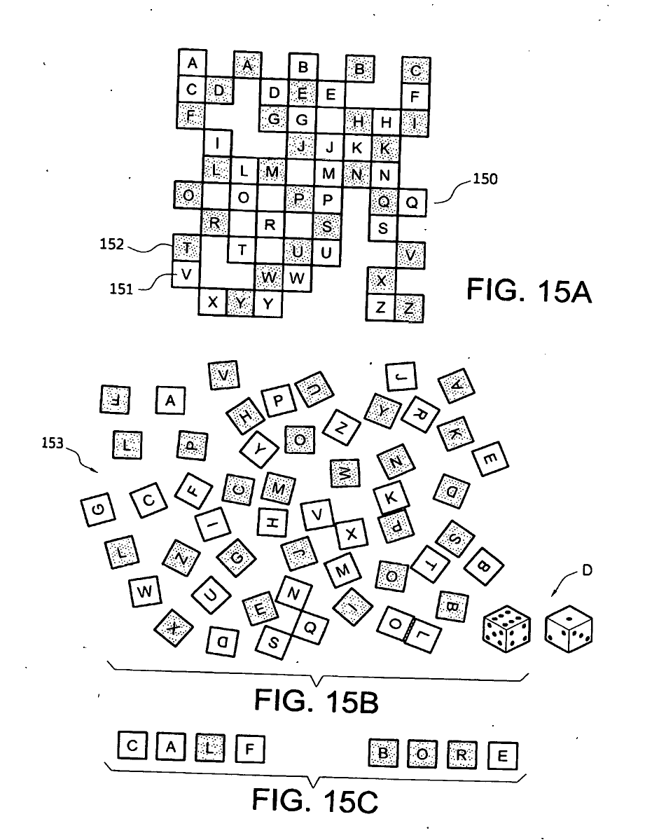

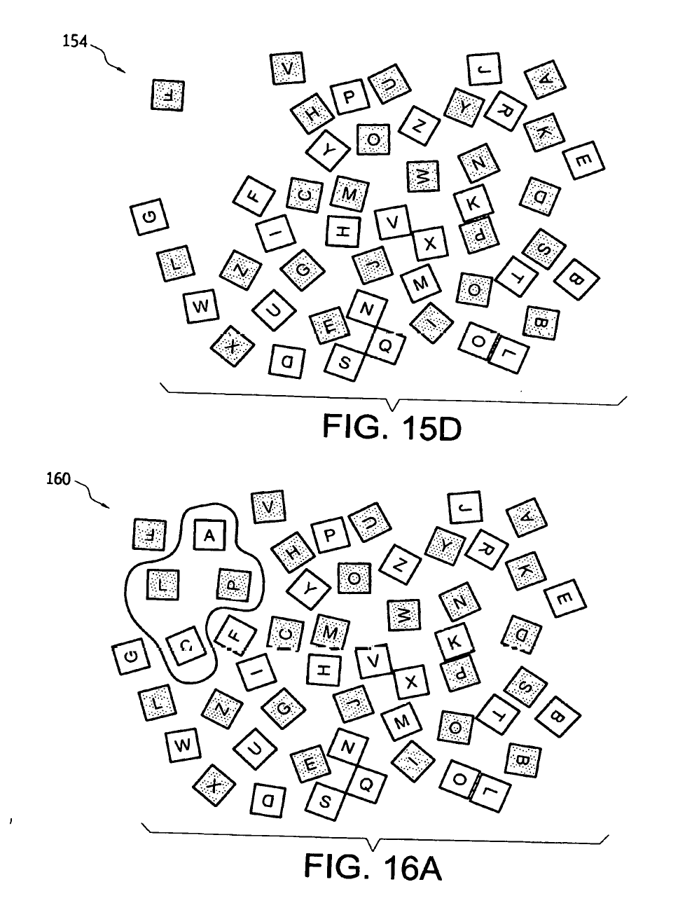

FIG. 15A shows lettered game pieces used in a game 150 according to the present invention. A first set of game pieces 151 has pieces that are colored white and all of which serve as game piece designators for a first player. A second set of game pieces 152 has pieces that are colored gray and all of which serve as game piece designators for a second player.

As shown in FIG. 15B, all the game pieces of both sets 151 and 152 are randomly placed in an arrangement 153. Play then commences with the first player attempting to make a word by choosing a game piece or pieces. Optionally, each player in each turn can be required to use at least one game piece which is a designator for the other player; and, optionally, if this is not done, a penalty can be assessed. A non-acting player whose designator is used receives a score as does the player making a word. A die or dice (e.g., the typical known six-faced dice D shown in FIG. 15B), as described above, may be used to determine by chance the score for the non-acting player.

As shown in FIG. 15C, the first player in the first turn makes the word “calf” which used one game piece designator of the other player, the letter “l.” The second player in the next turn makes the word “bore” which uses the first player's game piece designator “e.” For example, each player receives 5 points for the word made and each player receives 1 point for the other player's use of the game piece designator which is not that player's.

It is within the scope of the present invention for the players to return all pieces to the arrangement of FIG. 15B after a turn or after a turn of each player. Alternatively, pieces used in a word may be eliminated from further play (e.g, by removal from a game board or computer screen; or by turning them face down) and play progresses with the remaining pieces. For example, as shown with the arrangement of FIG. 15D, the pieces used for the words shown in FIG. 15C have been removed and the players proceed with the remaining pieces.

In one aspect of a game 150, an acting player who produces a produced word receives a score based on word length, the number of letters used in the produced word: one-letter word, 5 points; two-letter word, 10 points; three-letter word, 15 points; four-letter word, 20 points; and so forth in increments of 5 points as the number of letters increases. In this same game, a non-acting player whose designator is used in such a word is allowed to roll the dice D once and receives a designator score equal to the sum of the numbers face up on the rolled dice (in the case shown in FIG. 15B, this sum is 11 points). Thus, an acting player must consider the possible effects in terms of possible designator score that a non-acting player can receive if the acting player uses a designator of a non-acting player. To further enhance the strategy considerations, in all or some turns of play each acting player can be required to employ a non-acting player's designator or suffer a point penalty and/or forfeit a turn.

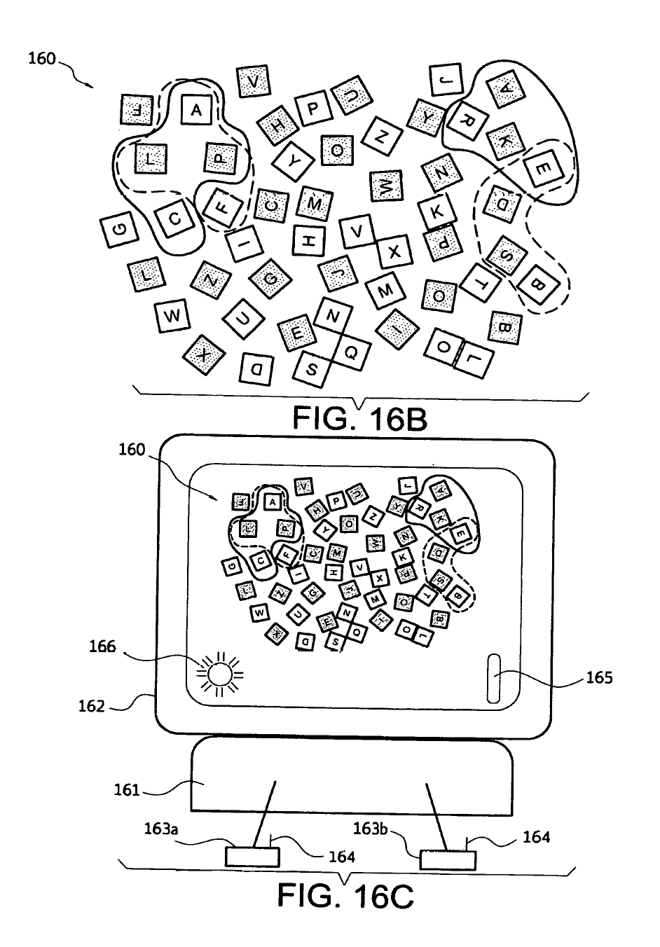

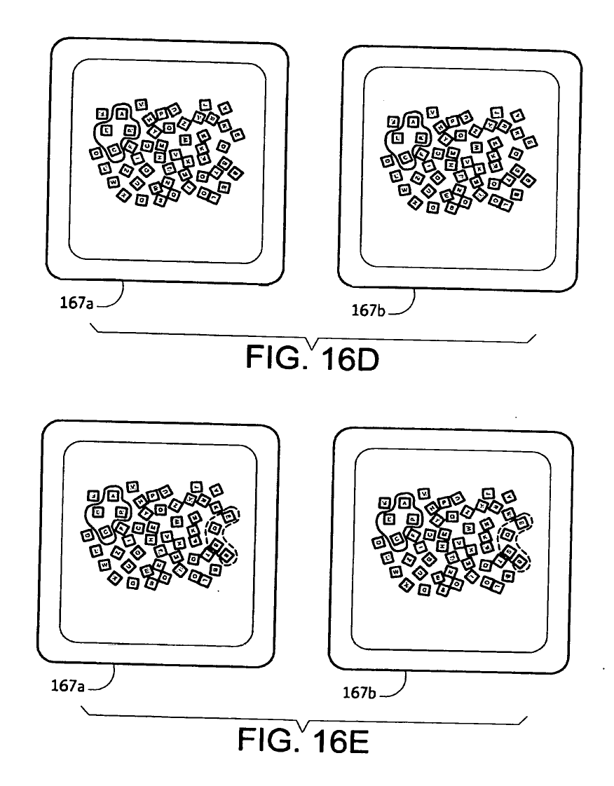

FIG. 16A shows a random arrangement of lettered game pieces as in FIG. 15B and the use of pieces in a game 160 according to the present invention in which each player finds words and makes a boundary around them or draws a line around them. In one aspect, the game 160 is a TRESPASS (trademark) game.

In a game 160, the letters may be presented on lettered game pieces—e.g., cards or tiles; they may be presented on a printed page or paper; or they may be presented on a computer screen.

In a game 160, a player may indicate the letters chosen for a produced word by, e.g., drawing a line around the chosen letters; placing a lace or string around the chosen letters; or using a touch screen make a line boundary around the chosen letters. Drawn lines may be of different nature (e.g., the solid line and the dotted line shown in FIG. 16A) or lines may be made with different colored pencils or different colored inks. On a computer screen, each player's created boundaries may be indicated by different colored lines and/or by different nature lines.

In FIGS. 16A and 16B the game 160 is shown with two players; but, as is true for any game according to the present invention, any suitable desired number of players may play the game.

As shown in FIG. 16A, a first player has drawn a line around the lettered game pieces to make the word “clap” which uses two designators of the first player, the letters “c” and “a,” and two designators of the second player, the letters “l” and “p.” Then the second player has drawn a line (shown as a dotted line) around the lettered game pieces to make the word “beds” which uses two designators of the first player, the letters “b and “e,” and two designators of the second player, the letters “s” and “d.”

Each player receives a score for finding a word and each player receives a score for the other player's use of the player's designators. Any agreed-on scoring system or method, including any disclosed or referred to herein, may be used. In one particular example, for the words shown in FIG. 16A, the first player receives a score of 8 points for the produced word “clap” and the second player receives 2 points for the first player's use of the second player's designators “1” and “p,”—1 point for each designator. The second player receives a score of 8 points for the produced word “beds” and the first player receives 2 points for the second player's use of the first player's designators “e” and “s”—1 point for each designator. Optionally, point scores can also be awarded for each individual letter used.

As play progresses, in one aspect, lettered game pieces used once may not be used again. In another aspect, a player may use a lettered game piece of another player that has already been used by having a point score added to the other player's point total. In another aspect, a player may use a lettered game piece of his or her own that has already been used by having a point score added to the other player's point total. In one aspect, no lettered game piece may be used more than twice.

As shown in FIG. 16B, the first player has made a second word, the word “rake” which uses two designators of the second player, the letters “a” and “k.” The first player has also used the letter “e” that is within the boundary line drawn by the second player in producing the word “beds” in the second player's first turn.

According to the present invention there are several scoring options for the first player's use of the letter “e” which was within the boundary established by the second player. One option is that the second player receives a score when the first player produces the word “rake” due to the use of the previously-used-by-the-second-player letter “e.” Another option is that, since the used letter “e” is a designator of the first player, that the second player gets no score for the first player's use of the letter “e.”

Another option is that the second player received one score if the letter used is a designator of the first player and a different score if the letter used is a designator of the second player. For example, with respect to the produced word “rake,” the first player receives 8 points and the second player receives 1 point for the first player's use of the first player's own designator, the letter “e.” However, if the letter used by the first player had been a designator of the second player, then the second player would have received 2 points.

As shown in FIG. 16B, the second player in the second player's following turn, makes the word “flap” (indicated by the dotted line around the letters “f,” “l,”“a,” and “p.” The second player receives a score for producing the word, and the first player receives a score based on three things: the second player's use of the first player's designator “l;” the second player's use of the first player's designator “p;” and the second player's use of the designators “l” and “p” which are within the boundary line of the first player for the word “clap” previously-produced by the first player.

For example, the second player receives 8 points for producing the word “flap.” The first player receives a total of 6 points: 2 points for the use of the first player's designators “a” and “c;” 2 points for the use of the first player's designator “c” within the boundary of the word “clap;” and 2 points for the use of the first player's designator “a” within the boundary of the word “clap.”

For example, as shown in FIG. 16C, the game 160 is played by two players on a computer 161 with a monitor 162 and game devices 163a and 163b (one game device for each of the two players). Using controls, mouse, and/or joysticks 164, the players indicate their word production by drawing the word boundary lines with the lines showing up on the monitor 162.

With appropriate software according to the present invention, the computer 161 provides the original letter arrangement on the monitor and automatically calculates scores for produced words.

It is within the scope of the present invention to provide electronic or digital versions of any game according to the present invention along with apparatuses and/or devices according to the present invention for playing the game using one or multiple screens, with the screens near each other or with the screens remote from each other and/or with electronic game pieces, including, but not limited to, the features and aspects of paragraphs [0002]-[0009] above. Any suitable known electronic and/or computerized gaming apparatuses, pieces, and devices may be used; including, but not limited to, computer with monitor, laptops, netbooks, tablets, touch screen computers, and electronic gaming platforms-these apparatuses and devices including software and media (and any needed hardware or peripheral devices) for the particular game—and including, but not limited to, individual electronic programmed game pieces, computerized individual game pieces, known “electronic cubes” and known “electronic tiles”, including such pieces that communicate with each other.

Optionally, a computer provides a timer; e.g., for timing each player's turn and/or for timing an entire game. Optionally, as in some forms of chess, initially a player is allotted a game total time to be used for word production and once that time is used up, the player can produce no more words. Optionally, on the monitor, a countdown timer can be provided for the game, and/or for each turn, and/or for each player.

Optionally, the computer provides an alert or warning (indicated by a circle-with-rays figure); visual and/or audio) either before a player uses a letter within another player's boundary (e.g., as a player begins to draw a boundary line near an already-enclosed designator) or after (and in one aspect, only after) a player draws a boundary line that includes a designator already within another player's boundary line. Optionally, any designator of another player can begin to blink or shine or otherwise be highlighted when a player begins a boundary line near such a designator and/or any area enclosed by a player's boundary line can blink or shine or otherwise be highlighted-either upon completion of such a line or when another player begins drawing a line near it, or both.

It is within the scope of the present invention for any computerized game according to the present invention to be played on multiple computers simultaneously, whether the computers are in the same location or not. In one aspect the computers have a touch screen or they are computerized touch screens.

For example, as shown in FIG. 16D, a game 160 may be played on two touch screen computerized devices 167a and 167b, with each of two players having one of the devices. The players can be together or they can be remote from each other and in communication via any suitable system or network, including, but not limited to, the Internet. As shown in FIG. 16D, the first player has produced the word “clap” on the device 167a and the production of this word has appeared on the other player's device 167b.

As shown in FIG. 16E, as play commences each player's actions are reproduced on the other player's device. FIG. 16E shows the second player's production of the word “beds.”

The present invention provides games (any disclosed herein) according to the president invention in electronic versions which include a computer apparatus (e.g., a desktop computer, a laptop, a netbook, a tablet computer, a computerized apparatus, a cellphone, a portable phone, a programmable logic controller apparatus or device, a portable computer apparatus, or a tablet) with the components (e.g., hardware, software, controls, input devices, circuits, game controls, joysticks, connections, electronic devises, screen or monitor, mouse, drive (s), memory, media, etc.) for one, two, or more persons to play the game on the computer apparatus or on multiple computer apparatuses.

For one person to play, the computer apparatus can be programmed to provide an “opponent” (or opponents) to play the game against the one player; or, on-line the web or network system can provide the “opponent” (or opponents). In one aspect, the opponent(s) are merely computer generated; in another aspect, real person(s) are the opponent(s).

In certain aspects, the present invention provides computer-readable media having computer executable instructions for playing a game (any according to the present invention), including embodiments with such instructions for playing any game disclosed herein according to the present invention.

In certain aspects, the present invention provides a computing unit configured to read and perform the computer-executable instructions (for any game herein; for any electronic game piece herein) on the computer-readable media. In certain aspects, the present invention provides such a computer-readable media with instructions that when executed cause a processor (including, but not limited to, one in a game piece) to make it possible for one, two or more players to play on a computer with the processor (and, in certain aspects, on one, two or more other apparatuses in communication with the computer with the processor) a game according to the present invention. Any such computing unit (stand alone or in a game piece) has instructions, software, and associated hardware, inter alia, for providing on a screen or monitor a visual presentation (and/or audio) of a game board, letter grid or arrangement, game area, and/or game pieces at game locations as well as providing visual presentation (and/or audio presentation) of each play, piece placement, each designator creation, turn and/or word produced as play progresses; in certain aspects, a visual presentation (and/or audio) of each aspect of scoring, each score, and running total scores for each player; and, in certain aspects, visual and/or audio presentation of time for each turn; total time for each player to expend for an entire game; and time for a game, optionally along with countdown timing presentation for any aspect of a game that is timed; and/or with any of the features or aspects as in any game herein, including, but not limited to, those described in the BRIEF SUMMARY OF THE INVENTION section above.

The present invention provides, for any game disclosed herein according to the present invention, a site for remote access at which one, two, or more persons can play, on a screen or screens, the game according to the present invention. In one aspect, the present invention provides, for any game according to the present invention, a computerized method for playing a game according to the present invention, the method including providing to the consumer a Web page to go to to initiate playing of the game and then to play the game on-line.

In certain aspects, the present invention provides a database for access by and/or use with a computer apparatus, the database including the history of a game played or games played according to the present invention, with, e.g., information for each produced word score; history of scoring during and throughout game(s); all players of a game over time, in certain aspects, with each score by each player, each word produced by each player, and/or total scores for each player for each game. Players can be identified or they can have aliases. The database can be an open database; password only accessible; or with certain sub-areas only password accessible.

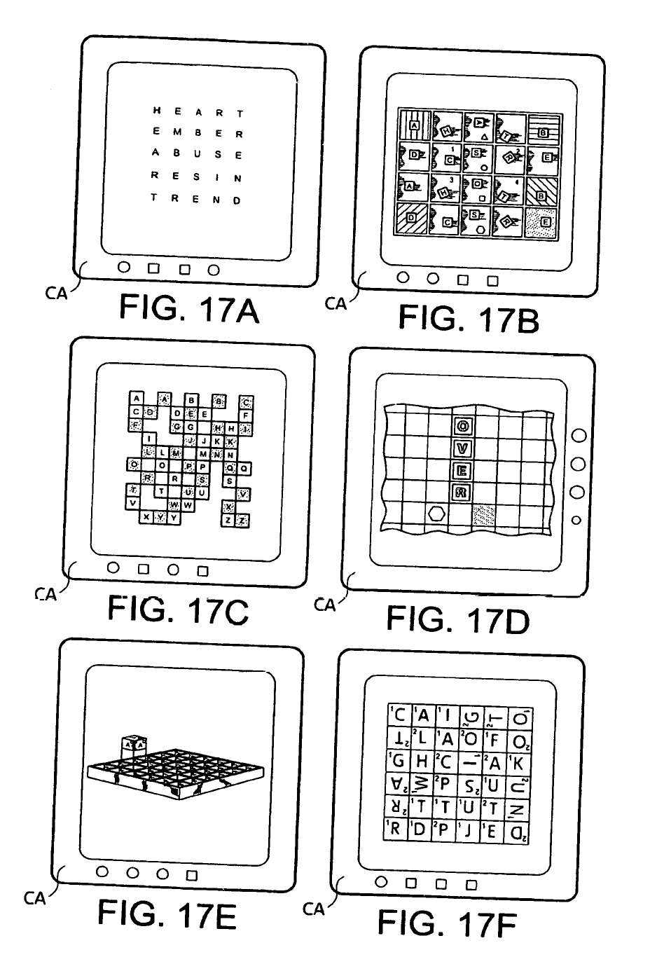

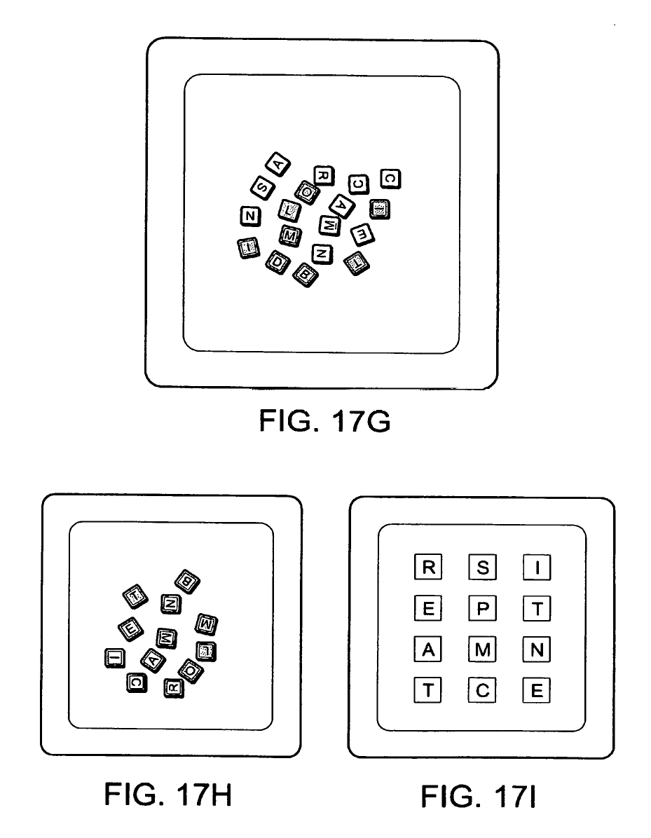

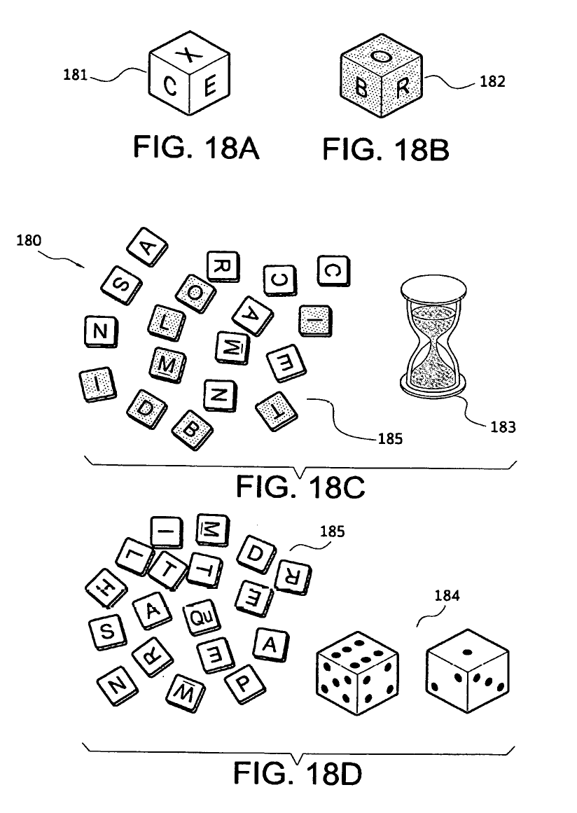

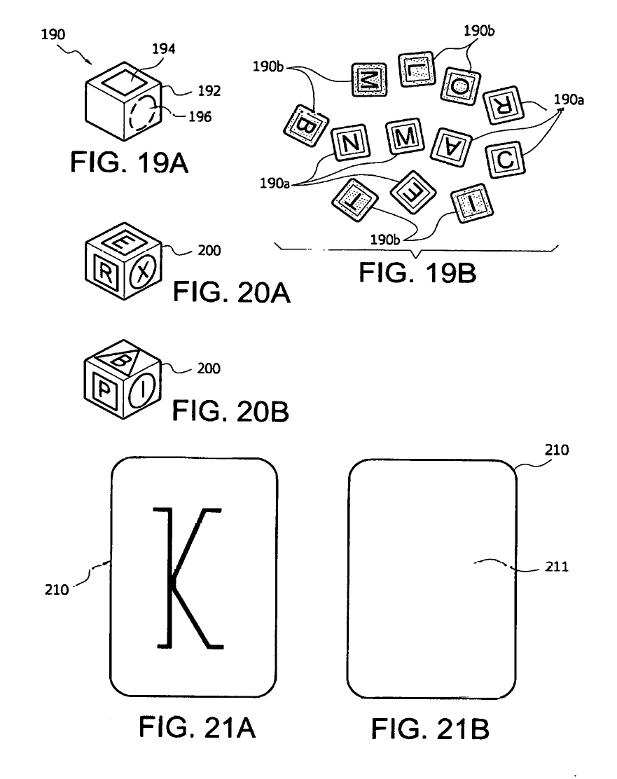

Regarding the computerization of each game according to the present invention—e.g, the above-described computer apparatuses, computer-readable media, computing units, sites, electronic game pieces, databases, and/or computer-executable instructions—all such computer apparatuses, etc. may be provided for any game according to the present invention. This is illustrated for the TRESPASS (Trademark) game as in FIGS. 16A-16E and games in FIGS. 17A-17I for certain games according to the present invention with a computer apparatus CA in each figure. The certain games according to the present invention in these FIGS. are as follows: FIG. 17A, DOUBLE TROUBLE (Trademark) game or a game 130 as in FIG. 13A; FIG. 17B, BANDIT (Trademark) game or a game 60 as in FIG. 6; FIG. 17C, ColorWords (Trademark) game or a game 150 as in FIG. 15A; FIG. 17D, ROLL 'EM (Trademark) game or a game 50 as in FIG. 5a; FIG. 17E, BARCBELS (Trademark) game or a game 70 as in FIG. 7; FIG. 17F, BOONDOGGLE (Trademark) game or a game as in FIGS. 1A-1D; a BUZZ (Trademark) game as in FIG. 19B; a game as described with respect to FIGS. 20, 21A, and 21B or a SURPRISE! (trademark) game; and a game 180 or a Throwdown (Trademark) game as in FIGS. 18A-18D.

In certain embodiments, in any game according to the present invention, an acting player during a turn for producing a word may have the option, at the player's discretion, to use a designator or designators of a non-acting player. In certain embodiments, in any game according to the present invention, an acting player during a turn for producing a word, may be required to use one, at least one, or more than one designator of a non-acting player. In certain embodiments, in any game according to the present invention, an acting player during a turn for producing a word, may be required to use a designator or designators of a non-acting player only if a scoring threshold has been achieved or passed; for example, at least one player has achieved a certain numerical point score total or the scores of all players, added up, produce a sum that meets or exceeds a certain total number of points-such totals specified in the rules or agreed on before play commences. Alternatively, an acting player may be required to use a designator of a non-acting player only once for every certain number of turns; e.g., once every two or three turns.

FIGS. 18A-18f illustrate a game 180 according to the present invention which may be, in certain aspects, a Throwdown (Trademark) game according to the present invention. In the game 180 each player has a set of multiple dice, each die with six letters, one letter on each face of the die. Each player's set may have any desired number of dice. As shown in one example in FIGS. 18A and 18B, a first player has a set of dice with each die 181 colored white; and a second player has a set of dice with each die 182 colored gray. Each die of each player's set serves as a designator for that player. As shown in FIG. 18A, each player's set of dice has eight dice.

To begin play the first player picks up all the dice of both players and rolls them onto a game support 185. The first player then produces a word using any or all of the sixteen dice. Use of a designator of the second player results in a score for the second player (awarded and/or determined in any way disclosed herein for a designator score). For example, for the roll of the dice as shown in FIG. 18C, the first player spells the word “romances” using all dice of the first player except for the letter “o” which is a designator of the second player. Optionally, a timer 183 may be used for a time period for the players to spell a word.

In one example, the first player receives a score of 50 points for making a word with eight letters. The second player rolls two dice 184 which turn up the numbers 4 and 3 and the second player, based on these numbers, receives a designator score of 7 points. Then, as shown in FIG. 18D, the second player rolls all sixteen dice and spells the word “dealers” which uses two designators of the first player, the letters “e” and “r.” The second player receives a score of 50 points for a word with seven letters; and the first player rolls the dice 184 two times—one time for each first-player designator used by the second player—each time rolling a 6 and a 1. The first player, therefore, receives two designator scores of 7 points each and a total of 14 points is awarded to the first player.

Any feature or aspect for any game according to the present invention described above or claimed below may be used with the game 180 (so long as non-contradictory features are not used), e.g. but not limited to, regarding play, timing, turns, scoring, authorities, etc.

In certain embodiments, in any game according to the present invention, an acting player during a turn for producing a word may have the option, at the player's discretion, to use a designator or designators of a non-acting player. In certain embodiments, in any game according to the present invention, an acting player during a turn for producing a word, may be required to use one, at least one, or more than one designator of a non-acting player. In certain embodiments, in any game according to the present invention, an acting player during a turn for producing a word, may be required to use a designator or designators of a non-acting player only if a scoring threshold has been achieved or passed; for example, at least one player has achieved a certain numerical point score total or the scores of all players, added up, produce a sum that meets or exceeds a certain total number of points-such totals specified in the rules or agreed on before play commences. Alternatively, an acting player may be required to use a designator of a non-acting player only once for every certain number of turns; e.g., once every two or three turns.

It is within the scope of the present invention, in any game according to the present invention, for the status of a game piece or game location, etc. as a designator to be known before an acting player begins to produce a word. In such a case, the acting player is fully aware of other players' designators and can produce words taking into account the knowledge that use of a designator will provide the non-acting player whose designator it is with an additional score or with the chance to receive an additional score.

Alternatively, it is within the scope of the present invention, in any game according to the present invention, for a status of a game piece or game location as a designator to be hidden while an acting player produces a word and then, once a word is finalized, for any game piece's designator status to be revealed. For example, each player can have a list on which the player lists designators before a turn commences; each player can have duplicate game pieces and can segregate a designator or designators before a turn commences, with the designator(s) revealed after a word is finalized by an acting player; or in embodiments in which electronic game pieces are used (as in games according to the present invention described below), the game pieces themselves can be programmed to initiate a designator status for a non-acting player (by chance or by choice of a non-acting player; known or unknown to the non-acting player) and then, when an acting player finalizes a word, reveal which piece is a designator of a non-acting player.

In any turn or round of turns in any game according to the present invention, there can be a bonus word determined by chance or determined by a player or players, before play commences. A player making the bonus word receives a pre-set or pre-agreed on bonus score. The bonus word can be determined by an electronic device (e.g., but not limited to, by an electronic computerized game piece) and can be revealed either at the end of a single player's turn or at the end of a round of turns in which each player has produced a word.

As illustrated in FIG. 19A, game pieces according to the present invention may be electronic devices, e.g., the game piece 190 which has a body 192, a display screen 194, and an internal electronic device 196. The device 196 may be any suitable computer, chip, processor, programmable logic processor, programmed processor, or electronic device useful as a game piece according to the present invention; including, but not limited to, known electronic pieces, including, but not limited to, the electronic games pieces, electronic “cubes,” or “electronic tiles” used in the SCRABBLE FLASH (trademark) game and the BOGGLE FLASH (trademark) game. Games may be played with any desired number of game pieces 190, including, but not limited to, the number of game pieces in any of the games described above or the number of game pieces in the SCRABBLE FLASH game and the BOGGLE FLASH game. The pieces or tiles are programmed to achieve the functions and results for the game pieces and game options described above for any game according to the present invention; and, in one aspect, include the SMARTLINK (trademark) technology of the SCRABBLE FLASH (trademark) game and the BOGGLE FLASH (trademark) game, with programming to accomplish the improvements according to the present invention. A game piece 190 can have a built in timer to time a player's turn and/or to provide an alert at the end of a turn or near the end of a turn.

With a game piece like the game piece 190, the screen 194 can display, at any desired time or point in a game, indicia indicating that the piece is a designator for a player. The indicia can be on display before a player begins a turn to produce a word or it can be revealed after a player makes a word or words. It can be revealed immediately after a player makes a word, or it can be revealed at the end of a player's turn, along with the number of times a non-acting player's designator was used in multiple words produced by an acting player during a turn. This can be revealed automatically when a pre-set turn time period runs out or it can be revealed by pressing a button 199 or otherwise activating or interrogating the piece 190. The designating indicia can be changed before each turn commences, automatically or manually.

The game pieces 190 or a game piece 190 can be programmed to provide an alert (visual and/or auditory and/or vibratory) when the piece is a designator of a player and/or when the piece is a designator of a player and has been used a certain number of times—a certain number of times by one acting player in one turn or a certain number of times in a pre-set number of individual turns. An additional score can be awarded to the non-acting player whose designator is used or the non-acting player can receive a chance or chances to receive an additional score. A game piece like the game piece 190 or like those used in the FLASH (trademark) games can be programmed to produce an additional score at random upon appropriate activation of the piece or automatically.

A game piece 190 can be programmed to blink on and off or with different colors, or with blinking letters or numeral, with an indicia indicating a designator of a particular player—continuously during a turn, at a pre-programmed time, or only after a word is finalized using the piece. If the game is one in which a non-acting player's designator must be used a multiple number of times for the non-acting player to receive an additional score or the chance for an additional score, the game piece (or any game piece in communication with the designator game piece) which is in the status of the non-acting player's designator can provide an alert when one more (or two more) uses are necessary for the additional score to be awarded (or chance for additional score). Thus, for example, when the game rules provide that a non-acting player's designator must be used three (3) times for the non-acting player to receive an additional score, the non-acting player's designator game piece provides an alarm, visual and/or auditory and/or vibratory, when it has been used by an acting player two times—so that the acting player knows that one more use of that piece will result in the award of the additional score to the non-acting player.

As shown in FIG. 19B, a plurality of game pieces 190 have been presented to an acting player for the acting player's word producing turn. Screens on six of the pieces 190a are shown as white in color—which is the indicia for designators of the acting player. Screens on six other pieces 190b are gray which is the indicia for designators of a non-acting player. Use of the pieces 190b by the acting player in producing words can—as specified in the rules and/or as agreed upon before play commences—result in an additional score for the non-acting player or for the chance (or chances) for an additional score for the non-acting player. Such pieces may be used in any suitable game according to the present invention. Also, a game according to the present invention includes such pieces (with any or all of the possibilities described above) used in combination with an improved version of the SCRABBLE FLASH (trademark) game and the BOGGLE FLASH (trademark) game (with the number of pieces specified and/or used by these games or with any other desired number of pieces). In one aspect the game illustrated in FIG. 19B is a BUZZ (trademark) game.

It is within the scope of the present invention for any game according to the present invention to be played with game pieces which have multiple sides, screens, facets, or faces and for at least one side, etc. to be out of sight or not viewable—and therefore unknowable by an acting player producing a word. In certain embodiments of games according to the present invention, the unknown face or side bearing a player designator is not revealed until after the piece is used by an acting player in producing a word-and it is the unknown side, etc. whose designator determines if a designator score or chance for such a score is given to the player whose designator it is.

For example, with a die having six faces, when the die is at rest and its top face has a particular letter showing that can be used in making a word, the bottom face of the die is not visible and the letter on that face is unknown to an acting player—and unknown to all players. Also, a designator on the bottom face is unknown while the piece is being considered for use in a produced word. Once a word is produced using the piece, the die is turned over to reveal whose designator is on the bottom face and, if it is not the designator of the acting player, then the player whose designator it is receives a designator score or gets the chance to receive an additional score. When the piece is an electronic block, tile, etc., the designator score can be pre-programmed into the piece and revealed manually or automatically once a word is finalized.

Similarly, if the game pieces are cards with two sides and one side has a letter and the other side has a player designator, an acting player to whom the designator side of the card has not been revealed can produce a word using the card without knowing whose designator is on the other side. Similarly with an electronic game piece, electronic tile, or interactive block, the piece, etc. can be programmed so that while it is being considered for use in a word and while it is being used in producing a word, the acting player producing the word does not know whose designator is associated with the piece—and the piece, either manually or automatically-can reveal whose designator it bears after the word is produced.

Thus an acting player will be surprised when a piece's designator is revealed and, while the acting player is producing a word during a turn in the game, the acting player must take into account the value of using a letter on a piece versus the possibility that the piece bears a designator of a player other than the acting player and the added value of producing a longer word, using a piece whose designator is unknown (and which may give another player a designator score or the chance to be awarded an additional score based on chance, a score that may equal or exceed the score the acting player receives for producing the word).

Such a “surprise” possibility can be in effect—when pieces with unviewable designators are used—for every turn of a game, for only a specified number of rounds of turns of a game, for only the last two rounds of turns or only on the last round of turns.

In certain games in which the acting player is surprised when the designators are revealed, in the situation in which a word is made and it is revealed that multiple designators of one single non-acting player have been used in a produced word, the rules may allow for that non-acting player to receive only one designator score or a designator score for each designator used (or one opportunity to receive a designator score by chance or multiple opportunities, one for each designator used).

FIGS. 20A and 20B show all the faces of a game piece 200 that is a die having a letter on each face and a player designator on each face. In this case the player designators are geometric shapes and, for example, when the dies comes to rest as in FIG. 20A, revealing a top face with a letter “E” and a square designator, the triangle designator on the bottom face bearing the letter “B” is not visible. In a game using this and a plurality of similar dice, it is the bottom face of the die at rest that determines which player's designator is operative for scoring (not the designator visible n the top face). An acting player whose designator is the circle, who used this die in producing a word, learns after the word is produced that the bottom face does not bear that player's designator and the player whose designator is the triangle receives a designator score or the opportunity to receive a designator score by chance.

In such games in which the acting player is surprised when the designators are revealed, in the situation in which a word is made and it is revealed that multiple designators of one single non-acting player have been used in a produced word, the rules may allow for that non-acting player to receive only one designator score or a designator score for each designator used (or one opportunity to receive a designator score by chance or multiple opportunities, one for each designator used).

Another embodiment of a SURPRISE game uses cards that have a letter on one side and a player designator on the other side. As shown in FIG. 21A, a card 210 has a letter, e.g., the letter “K,” on one side, and, as shown in FIG. 21B, has a color designator 211 on the other side. However many cards are in a group or deck of cards for each player, each player's group or deck has the same player designator so that each player has the same number of cards and the cards in each group or deck bear the same letters as every other group or deck.

For example, in a first mode of a round of turns in playing a game with decks of cards as in FIGS. 21A and 21B, in one round of turns in a particular turn each player shuffles or otherwise mixes up a deck of cards and places the deck with the top card's designator showing. For example, with four players each has a deck of any desired number of cards (e.g., but not limited to ten, twenty, twenty-six—one with each letter of the alphabet, or thirty—one with each letter of the alphabet and six extra vowel cards), each card with a color designator, e.g., the four colors red, green, yellow, and blue are used. Before play commences, each player turns up from a shuffled deck, the top four cards and places them so that an acting player can view all the upturned cards—in this case, sixteen cards, four of the acting player and four each of the other three non-acting players.

The acting player then has a pre-set time period in which to spell a word using from one to sixteen of the upturned cards. Upon finalizing a produced word, each card used in the word is turned over to reveal its designator. Any card with a designator of the acting player results in no designator score for any other player. In this particular game, each card that reveals the designator of a non-acting player results in a designator score for that non-acting player or in the opportunity for receiving a score by chance.

It is within the scope of the present invention to use, in one game and in one turn of one game, a rotating method of awarding designator scores if multiple designators of one non-acting player are used in a produced word. For example, in a situation in which an acting player uses three designators of a particular non-acting player, that non-acting player receives a pre-set designator score for the first two designators used and then gets one opportunity to receive a score by chance, e.g., by rolling dice, spinning a number wheel, or pushing a button on a pre-programmed electronic block or tile. It is within the scope of the present invention to award any number of set designator scores and any number of opportunities to receive an additional score by chance.

In another exemplary round of turns of a game according to the present invention—a second example of turns—using cards as in FIGS. 21A and 21B, each player shuffles a deck of the cards with the letters up so that both during shuffling and after shuffling the letter sides are up and no designators are showing. With letters showing, each player moves the top three cards from their deck and places them in a pile. The pile is then shuffled, with the letter sides up and remaining up during and after shuffling. The cards are then all spread out in the view of the next acting player so that all cards, all letters are visible. Now the acting player has twelve letters on twelve cards to choose from in producing a word-the three cards of the acting player, each showing a letter, and nine cards from the non-acting players, each showing a letter. At this point, no player knows the designator of any card being used in this turn of play. Once the acting player finalizes a word, then each card is turned over and, for the first time during the turn, the designator on each cards designator side is revealed. Scoring then proceeds for the use of designators in any way described herein agreed upon by the players and/or as set in accepted rules.

In another exemplary round of turns of a game according to the present invention—a third example—using cards as in FIGS. 21A and 21B, there is a deck of cards and the deck includes cards with designators for each player. For example, with two players a deck of fifty cards includes a first set with all letters of the alphabet on one side (one letter per card) and a designator for a first player on the other sides; and a second set of twenty six cards has all the letters of the alphabet on one side (one letter per card) and the second player's designator on the other sides. Optionally, the deck has a set of cards for each player, no matter how many players there are.

In this third example, with such a deck, in one mode the cards—all of them—are shuffled together with the letters facing up and with the designators face down and kept secret until after a word has been produced and finalized. After the cards are shuffled, some or all of the cards (number pre-set by the rules or pre-agreed upon by the players) are dealt or placed before the next acting player. This acting player can see the exposed letters but cannot see the designators on the face-down sides of the cards. The acting player produces a word using the letters that are visible. Once the word is finalized, then the cards are turned over to reveal the designators and designator scores are awarded or an opportunity or opportunities for an additional score awarded based on chance is given to each non-acting player whose designator was used in the word. Optionally—and this applies to any game according to the present invention—a designator score and/or chance or chances for an additional score based on chance can be given to the acting player based on the acting player using cards with the acting player's own designator—and this can be awarded based on the acting player using only one of the acting player's own designators or a multiple of such designators can be required (e.g., two, three or more)—which would give the acting player more reason to produce longer words since the acting player would increase the acting player's chances of receiving a designator score or chance for additional score.

It is within the scope of the present invention to use, in one game and in one turn of one game, a rotating method of awarding designator scores if multiple designators of one non-acting player are used in a produced word. For example, in a situation in which an acting player uses three designators of a particular non-acting player, that non-acting player receives a pre-set designator score for the first two designators used and then gets one opportunity to receive a score by chance, e.g., by rolling dice, spinning a number wheel, or pushing a button on a pre-programmed electronic block or tile. It is within the scope of the present invention to award any number of set designator scores and any number of opportunities to receive an additional score by chance.

In another exemplary round of turns of a game according to the present invention using cards, each player shuffles a deck of the cards with the letters up so that both during shuffling and after shuffling the letter sides are up and no designators are showing. With letters showing, each player moves the top three cards from their deck and places them in a pile. The pile is then shuffled, with the letter sides up and remaining up during and after shuffling. The cards are then all spread out in the view of the next acting player so that all cards, all letters are visible. Now the acting player has twelve letters on twelve cards to choose from in producing a word—the three cards of the acting player, each showing a letter, and nine cards from the non-acting players, each showing a letter. At this point, no player knows the designator of any card being used in this turn of play. Once the acting player finalizes a word, then each card is turned over and, for the first time during the turn, the designator on each cards designator side is revealed. Scoring then proceeds for the use of designators in any way described herein agreed upon by the players and/or as set in accepted rules.

In another exemplary round of turns of a game according to the present invention using cards, there is a deck of cards and the deck includes cards with designators for each player. For example, with two players a deck of fifty cards includes a first set with all letters of the alphabet on one side (one letter per card) and a designator for a first player on the other sides; and a second set of twenty six cards has all the letters of the alphabet on one side (one letter per card) and the second player's designator on the other sides. Optionally, the deck has a set of cards for each player, no matter how many players there are.

In this third example, with such a deck, in one mode the cards—all of them—are shuffled together with the letters facing up and with the designators face down and kept secret until after a word has been produced and finalized. After the cards are shuffled, some or all of the cards (number pre-set by the rules or pre-agreed upon by the players) are dealt or placed before the next acting player. This acting player can see the exposed letters but cannot see the designators on the face-down sides of the cards. The acting player produces a word using the letters that are visible. Once the word is finalized, then the cards are turned over to reveal the designators and designator scores are awarded or an opportunity or opportunities for an additional score awarded based on chance is given to each non-acting player whose designator was used in the word. Optionally—and this applies to any game according to the present invention—a designator score and/or chance or chances for an additional score based on chance can be given to the acting player based on the acting player using cards with the acting player's own designator—and this can be awarded based on the acting player using only one of the acting player's own designators or a multiple of such designators can be required (e.g., two, three or more)—which would give the acting player more reason to produce longer words since the acting player would increase the acting player's chances of receiving a designator score or chance for additional score.

As may be true for any game according to the present invention, in the first, second or third example of a mode for a turn for producing a word, designator scoring can be limited to the use of only certain letters. For example, only a card with a vowel that bears a non-acting player's designator can result in the award of a designator score or additional score opportunity for a non-acting player; or a letter or letters for which designator scoring will be possible can be indicated by random choice of letters in any suitable method for choosing them, e.g., by turning up three previously unshown cards from a deck and the letters of those cards indicate the letters for which designator scoring is possible. One option is that all vowel cards and the letter “S” cards provide designator scoring.

It is within the scope of the present invention to use the modes of play as described above-first example, second example, and third example, with any scoring method described herein for both producing a word and for designator scoring—for all turns and all rounds of turns of the game are according to only one of the examples; different modes are used in one game with different rounds of turns following different examples; and/or in one particular game, there are three rounds of turns and each round follows a different one of the examples.

A game that uses a piece or pieces with designators kept secret until after a word has been produced, with the designators then revealed, is, in certain aspects, a SURPRISE! (trademark) game according to the present invention.

In certain aspects, the present invention provides improvements to the known BANANAGRAMS (trademark) game. In one aspect, the improved game includes one, two, three, four, or more “joker” tiles that may be used as any letter.

In one aspect, the improved game includes one, two, three, four, five-ten, or more “black spot” tiles. In one aspect, when a player chooses a tile and turns it over to reveal that it is a “black spot” tile, that player must then take a pre-set or pre-agreed on number of additional tiles. In one aspect, a player must have chosen multiple (two, three, or more) “black spot” tiles before the player must take additional tiles.

In certain aspects, the improved game includes one, two, three, five-ten, or more “sharing” tiles. When a player chooses and then reveals a “sharing” tile, that player picks a designated number of additional tiles (one. Two, three, four, five-ten, or more) and gives them (“shares”) them with another player who then must play those tiles. The player who receives the shared tiles can be at the choice of the player who initially chose the “sharing” tile; or the player receiving the shared tiles can be pre-set or pre-designated—e.g., but not limited to, a player to the left of, to the right of, or across from the player initially choosing the “sharing” tile.

In certain aspects, such an improved BANANAGRAMS (trademark) game includes the use of one, two, three, four, five-ten, or more “safe” tiles. A player having a safe tile may use it to thwart the effect of a “black spot” tile or of a “sharing” tile; e.g., upon choosing a “black spot” tile, the player can negate its effect by giving up a “safe” tile previously chosen; or, upon an attempt by a first player to give a second player “shared” tiles, the second player can negate the effort by giving up a previously-chosen “safe” tile. A safe tile, in one embodiment, bears a designator of a specific player and can only be used to thwart “black spot” or “sharing” efforts Of that designated player. Applicant does not waive the right to claim each and every invention disclosed herein by presenting the following claims.

What is claimed is:

1. A method for playing a word game, the word game playable by a plurality of players,
the plurality of players comprising at least a first player and a second player,
the word game comprising a game piece location structure, the game piece location structure having multiple game piece locations, the multiple game piece locations including a first plurality of first game piece locations each with a location designator indicating the first player and a second plurality of game piece locations each with a location designator indicating the second player, each location designator either preprinted on the game piece location structure or created on the game piece location structure before the game commences, the word game further comprising a plurality of lettered game pieces each placeable on a game piece location of the game piece location structure and positionable adjacent each other to form words produced by the players, a first group of the plurality of lettered, game pieces having indicia thereon indicating the first player and a second group of the
plurality of lettered game pieces having indicia thereon indicating the second player,
the method comprising
the players receiving point scores of game points for producing a word,
the first player producing a first word, the first player producing the first word using at least one lettered game piece, the first player producing the first word toy placing the at least one lettered game piece on a game piece location of the game piece location structure and positioning the at least one lettered game piece to spell out the first word, the first word produced toy the first player alone in a first turn,
the first player receiving a first point score of game points for production of the first word,
the second player taking no action in the game during the first player's production of the first word during the first turn, and
the second player receiving a second point score of game points based on the first word if the at least one lettered piece used to produce the first word is from the second group indicating the second player.

2. The method of claim 1 further comprising
the second player receiving an additional point score of game points if the first word includes any lettered game piece positioned on a game piece location with a location designator indicating the second player.

3. The method of claim 1 wherein the game piece location structure is a board with multiple locations on which a game piece is placeable, the method further comprising
the players forming words by placing lettered game pieces on at least one location of the board.

4. The method of claim 1 further comprising
requiring the first player in the first turn producing the first word using at least one lettered game piece from the second group of lettered game pieces so that the second player receives a second point score.

5. The method of claim 1 further comprising
one of the players revealing whether the at least one lettered game piece used to produce the first word is from the second group after the first turn is completed.

6. The method of claim 1 wherein the lettered game pieces are one of die, tile, card, and electronic game piece.

7. The method of claim 1 wherein the second point score is determined by taking a percentage of the first point score awarded to the first player and wherein the percentage is determined toy one of game rules, a pre-game agreement, and toy chance, the method further comprising
the players determining the second point score.

8. The method of claim 1 wherein the method is effected electronically.

9. The method of claim 1 wherein the method is effected over the Internet.

10. The method of claim 1 wherein the second point score is one of greater than, less than, or equal to the first point score.

11. The method of claim 1 wherein the second point score is based on the at least one lettered game piece being from the second group and the second point score is determined by chance.

12. The method of claim 1 wherein the at least one lettered game piece is from the second group, and the method further comprising
determining a game point value for the second point score by using a die or dice by one of the following:
a die is rolled and shows a die face with a numeral thereon and the value of the numeral is the second point score;
a die is rolled and shows a die face with a numeral thereon and the value of the second point score is the first point score times the numeral value of the numeral;
two dice are rolled. and a face of each die shows on a die face a numeral and the combined value of the two numerals is the second point score; and
two dice are rolled and each shows a die face with a numeral thereon and the second point score is the first point score times the combined numeral value of the two numerals.

13. The method of clam 1 wherein the game is an improved version of an existing word game, the existing word game being one of SCRABBLE (Trademark) game and BOGGLE (Trademark) game.

14. A method for playing a word game, the word game playable by a plurality of players, the plurality of players comprising at least a first player and a second player,
the word game comprising
the word game comprising a game piece location structure, the game piece location structure comprising a board having multiple game piece locations, the multiple game piece locations including a first plurality of first game piece locations each with a location designator indicating the first player and a second plurality of game piece locations each with a location designator indicating the second player, each location designator either preprinted on the game piece location structure or created on the game piece location structure before the game commences, the word game further comprising a plurality of lettered game pieces each placeable on a game piece location of the game piece location structure and positionable adjacent each other to form words produced by the players, a first group of the plurality of lettered game pieces having indicia thereon indicating the first player and a second group of the plurality of lettered game pieces having indicia thereon indicating the second player,
the method comprising
the first player producing a first word, the first player producing the first word using at least one lettered game piece, the first player producing the first word by positioning the at least one lettered, game piece to spell out the first word, the first word produced by the first player alone in a first turn,
the first player receiving a first point score of game points for production of the first word,
the second player taking no action in the game during the first player's production of the first word during the first turn,
the second player receiving a second point score of game points based on the first word if the at least one lettered piece used to produce the first word is from the second group indicating the second player,
the second player receiving an additional point score of game points if the first word includes any lettered game piece positioned on a game piece location with a location designator indicating the second player,
wherein the second point score is determined by chance.

15. The method of claim 14 wherein the method is effected electronically or over the Internet.

16. The method of claim 14 wherein the game piece location structure is a container with multiple compartments for holding a game piece, the method further comprising
the players forming words by placing lettered game pieces in at least one compartment of the container.

17. The method of claim 14 wherein the game piece location structure is a board with multiple locations on which a game piece is placeable, the method further comprising
the players forming words by placing lettered game pieces on at least one location of the board.

18. The method of claim 14 further comprising
requiring the first player in the first turn producing the first word using at least one lettered game piece from the second group of lettered game pieces so that the second player receives a second point score.

19. A game, the game comprising a word, game, the word, game playable by a plurality of players, the plurality of players comprising at least a first player and a second player,
the word game comprising
a game piece location structure, the game piece location structure comprising a board having multiple game piece locations,
the multiple game piece locations including a first plurality of first game piece locations each with a location designator indicating the first player and a second plurality of game piece locations each with a location designator indicating the second player,
each location designator either preprinted on the game piece location structure or created on the game piece location structure before the game commences,
a plurality of lettered game pieces each placeable on a game piece location of the game piece location structure and positionable adjacent each other to form words produced by the players.

20. The game of claim 19 wherein a first group of the plurality of lettered game pieces has indicia thereon indicating the first player and a second group of the plurality of lettered game pieces has indicia thereon indicating the second player.
